(19) United States
(12) Patent Application Publication
(10) Pub. No.: US 2023/0171750 A1
(43) Pub. Date: Jun. 1, 2023

(54) METHOD OF TRANSMITTING SIDELINK POSITIONING REFERENCE SIGNAL, AND APPARATUS THEREFOR

(71) Applicant: ELECTRONICS AND TELECOMMUNICATIONS RESEARCH INSTITUTE, Daejeon (KR)

(72) Inventors: Jung Hoon LEE, Daejeon (KR); Cheul Soon KIM, Daejeon (KR); Sung Hyun MOON, Daejeon (KR)

(73) Assignee: ELECTRONICS AND TELECOMMUNICATIONS RESEARCH INSTITUTE, Daejeon (KR)

(21) Appl. No.: 18/070,292

(22) Filed: Nov. 28, 2022

(30) Foreign Application Priority Data
Nov. 29, 2021 (KR) 10-2021-0167590
Apr. 18, 2022 (KR) 10-2022-0047676
Sep. 26, 2022 (KR) 10-2022-0121534
Nov. 22, 2022 (KR) 10-2022-0157084

(51) Int. Cl. H04W 72/0446; H04L 5/00; H04W 72/40; H04W 64/00

(52) U.S. Cl. CPC H04W 72/0446; H04L 5/0051; H04W 64/003; H04W 72/40

(57) ABSTRACT

Disclosed are a method for SL-PRS transmission and a method for configuring SL-PRS transmission. A SL-PRS transmission method performed by a first terminal may comprise: receiving configuration information for SL-PRS transmission; and transmitting a SL-PRS based on the configuration information, wherein the configuration information includes information indicating SL slot(s) and symbols within the SL slot(s) in which the SL-PRS is transmitted.

### CROSS-REFERENCE TO RELATED APPLICATIONS

This application claims priority to Korean Patent Applications No. 10-2021-0167590 filed on Nov. 29, 2021, No. 10-2022-0047676 filed on Apr. 18, 2022, No. 10-2022-0121534 filed on Sep. 26, 2022, and No. 10-2022-0157084 filed on Nov. 22, 2022 with the Korean Intellectual Property Office (KIPO), the entire contents of which are hereby incorporated by reference.

### BACKGROUND

### 1. Technical Field

The present disclosure relates to a positioning technique in a mobile communication system, and more particularly, to a method for transmitting a sidelink (SL) positioning reference signal (PRS) in a mobile communication system, and an apparatus therefor.

### 2. Related Art

The NR system has introduced functions for supporting NR-based positioning technologies from Release-16, and improvements have been made to improve the performance of positioning technologies in Release-17. However, the corresponding positioning technologies are all positioning technologies based on a Uu link-based between a terminal and a base station, and sidelink-based positioning technologies are not yet supported in the NR system. The sidelink-based V2X services require sidelink-based positioning technology support for collision avoidance or location tracking, and these technologies should be supported not only in-coverage situations but also in out-of-coverage situations. In addition, sidelink-based positioning technologies need to be supported for sidelink-based public safety services and other services. In order to support such the sidelink-based positioning technologies, transmission of a sidelink SL-PRS for precise positioning may be required. Accordingly, the present disclosure proposes SL-PRS transmission methods for supporting the sidelink-based positioning technologies.

### SUMMARY

Accordingly, exemplary embodiments of the present disclosure are directed to providing a SL-PRS transmission method performed by a first terminal, and a method for configuring SL-PRS transmission of the first terminal, which is performed by a base station to which the first terminal is connected, a location management function (LMF), or a second terminal belonging to a group of terminals performing sidelink positioning with the first terminal.

Accordingly, exemplary embodiments of the present disclosure are also directed to providing configurations of apparatuses for performing the SL-PRS transmission method and the SL-PRS transmission configuration method.

According to a first exemplary embodiment of the present disclosure, a SL-PRS transmission method performed by a first terminal may comprise: receiving configuration information for SL-PRS transmission; and transmitting a SL-PRS based on the configuration information, wherein the configuration information includes information indicating sidelink (SL) slot(s) and symbols within the SL slot(s) in which the SL-PRS is transmitted.

The SL slot(s) in which the SL-PRS is transmitted may be configured regardless of a resource pool for sidelink data transmission and reception, or configured in a separate resource pool for SL-PRS transmission.

The SL-PRS may be transmitted in last N symbol(s) excluding a last guard symbol within a first slot among the SL slot(s) in which the SL-PRS is transmitted, the N symbol(s) may or may not include an automatic gain control (AGC) symbol, and N may be a natural number equal to or greater than 1.

The SL-PRS may be transmitted in a first frequency region other than a frequency region in which a physical sidelink control channel (PSCCH), a physical sidelink shared channel (PSSCH), and a physical sidelink broadcast channel (PSBCH) are transmitted.

The first frequency region may be indicated by an index indicating a starting resource block (RB) or a starting subchannel and a number of consecutive RBs or subchannels.

The SL-PRS may be mapped in a comb-type form at an interval of D subcarriers within the first frequency region; when the SL-PRS is transmitted in a plurality of symbols, the SL-PRS may be transmitted in the plurality of symbols by applying a different frequency offset to each symbol of the plurality of symbols; and D may be a natural number equal to or greater than 2.

The configuration information may be received from a first base station to which the first terminal is connected, a location management function (LMF), or a second terminal belonging to a group of terminals performing sidelink positioning with the first terminal.

From which communication node among the first base station, the LMF, and the second terminal the configuration information is received is determined according to whether the first terminal is in an in-coverage state or an out-of-coverage state and/or a configuration of the first base station.

The SL-PRS may be transmitted in a periodic transmission scheme, a semi-persistent/periodic transmission scheme, or an aperiodic transmission scheme.

When a trigger indicator is received from the first base station or the second terminal, the SL-PRS may be repeatedly transmitted a predetermined number of times in the aperiodic transmission scheme, and the predetermined number may be a preset value, a value signaled as being included in the configuration information, or a value signaled by a medium access control-control element (MAC-CE) or sidelink control information (SCI).

The configuration information may further include information on a periodicity and/or offset of the SL-PRS transmission, and when the SL-PRS is transmitted in the periodic transmission scheme, the periodicity of the SL-PRS transmission may be set to match a transmission periodicity of a physical sidelink feedback channel (PSFCH) or to be a multiple of the transmission periodicity of the PSFCH.

Different offsets may be applied to a slot in which the SL-PRS is transmitted and a slot in which the PSFCH is transmitted, or a same offset may be applied to the slot in which the SL-PRS is transmitted and the slot in which the PSFCH is transmitted.

According to a second exemplary embodiment of the present disclosure, an operation method of a communication node for configuring SL-PRS transmission may comprise: transmitting, to a first terminal, configuration information for SL-PRS transmission; and receiving, from a group of terminals performing sidelink positioning with the first terminal, a measurement result of a SL-PRS transmitted by the first terminal based on the configuration information, wherein the configuration information includes information indicating sidelink (SL) slot(s) and symbols within the SL slot(s) in which the SL-PRS is transmitted.

The SL slot(s) in which the SL-PRS is transmitted may be configured regardless of a resource pool for sidelink data transmission and reception, or configured in a separate resource pool for SL-PRS transmission.

The SL-PRS may be transmitted in a first frequency region other than a frequency region in which a physical sidelink control channel (PSCCH), a physical sidelink shared channel (PSSCH), and a physical sidelink broadcast channel (PSBCH) are transmitted.

The SL-PRS may be mapped in a comb-type form at an interval of D subcarriers within the first frequency region; when the SL-PRS is transmitted in a plurality of symbols, the SL-PRS may be transmitted in the plurality of symbols by applying a different frequency offset to each symbol of the plurality of symbols; and D may be a natural number equal to or greater than 2.

The communication node may be a first base station to which the first terminal is connected, a location management function (LMF), or a second terminal belonging to a group of terminals performing sidelink positioning with the first terminal.

According to a third exemplary embodiment of the present disclosure, a first terminal performing SL-PRS transmission may comprise: a processor; and a transceiver controlled by the processor, wherein the processor is configured to perform: receiving configuration information for SL-PRS transmission through the transceiver; and transmitting a SL-PRS through the transceiver based on the configuration information, wherein the configuration information includes information indicating sidelink (SL) slot(s) and symbols within the SL slot(s) in which the SL-PRS is transmitted.

The SL slot(s) in which the SL-PRS is transmitted may be configured regardless of a resource pool for sidelink data transmission and reception, or configured in a separate resource pool for SL-PRS transmission.

The SL-PRS may be transmitted in a first frequency region other than a frequency region in which a physical sidelink control channel (PSCCH), a physical sidelink shared channel (PSSCH), and a physical sidelink broadcast channel (PSBCH) are transmitted, the SL-PRS may be mapped in a comb-type form at an interval of D subcarriers within the first frequency region, and when the SL-PRS is transmitted in a plurality of symbols, the SL-PRS may be transmitted in the plurality of symbols by applying a different frequency offset to each symbol of the plurality of symbols. D may be a natural number equal to or greater than 2.

According to the exemplary embodiments of the present disclosure, SL-PRS transmission methods may be provided. Therefore, the performance of the communication system can be improved.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating a first exemplary embodiment of a type 1 frame.

FIG. 4 is a conceptual diagram illustrating a first exemplary embodiment of a type 2 frame.

FIG. 5 is a conceptual diagram illustrating a first exemplary embodiment of a transmission method of SS/PBCH block in a communication system.

FIG. 6 is a conceptual diagram illustrating a first exemplary embodiment of an SS/PBCH block in a communication system.

FIG. 7 is a conceptual diagram illustrating a second exemplary embodiment of a method of transmitting SS/PBCH blocks in a communication system.

FIG. 8 is a conceptual diagram for describing time domain transmission positions of SSBs according to a subcarrier spacing and L.

FIG. 9A is a conceptual diagram illustrating an RMSI CORESET mapping pattern #1 in a communication system, FIG. 9B is a conceptual diagram illustrating an RMSI CORESET mapping pattern #2 in a communication system, and FIG. 9C is a conceptual diagram illustrating an RMSI CORESET mapping pattern #3 in a communication system.

FIG. 10 is a conceptual diagram for describing an example of PSFCH configuration within one slot.

FIG. 11 is a conceptual diagram for describing an example of configuring PSFCH resources according to a PSFCH transmission periodicity.

FIG. 12 is a conceptual diagram illustrating exemplary embodiments of a method for multiplexing a control channel and a data channel in sidelink communication.

FIGS. 13A and 13B are conceptual diagrams illustrating cases in which N symbol(s) for SL-PRS transmission are configured within a SL slot according to an exemplary embodiment of the present disclosure.

FIG. 14 is a conceptual diagram illustrating an example in which a separate resource region for SL-PRS transmission is configured within a SL resource pool according to an exemplary embodiment of the present disclosure.

FIG. 15 is a conceptual diagram illustrating an example in which a resource pool for SL-PRS transmission is configured separately from SL resource pools configured for sidelink data transmission and reception according to an exemplary embodiment of the present disclosure.

FIG. 16 is a conceptual diagram for describing SL-PRS sequence mapping within a resource region for SL-PRS transmission according to an exemplary embodiment of the present disclosure.

FIG. 17 is a conceptual diagram illustrating a case in which a collision occurs between a slot in which a SL-PRS is transmitted and a slot in which a PSFCH is transmitted according to an exemplary embodiment of the present disclosure.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, ‘at least one of A and B’ may mean ‘at least one of A or B’ or ‘at least one of combinations of one or more of A and B’. Also, in exemplary embodiments of the present disclosure, ‘one or more of A and B’ may mean ‘one or more of A or B’ or ‘one or more of combinations of one or more of A and B’.

In exemplary embodiments of the present disclosure, ‘(re)transmission’ may mean ‘transmission’, ‘retransmission’, or ‘transmission and retransmission’, ‘(re)configuration’ may mean ‘configuration’, ‘reconfiguration’, or ‘configuration and reconfiguration’, ‘(re)connection’ may mean ‘connection’, ‘reconnection’, or ‘connection and reconnection’, and ‘(re-)access’ may mean ‘access’, ‘re-access’, or ‘access and re-access’.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may be used in the same sense as a communication network.

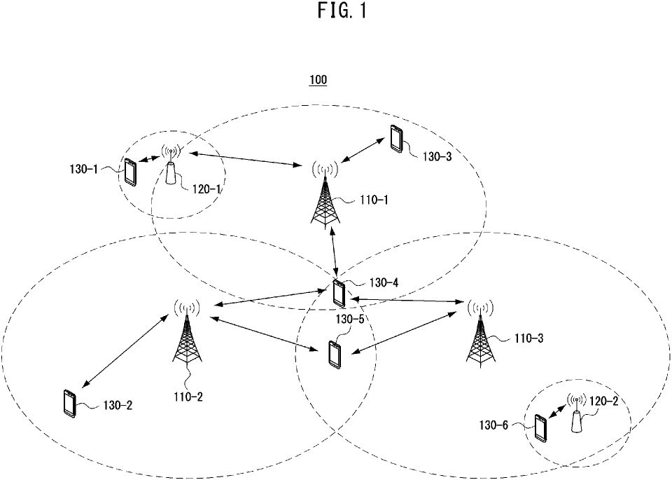

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further comprise a core network (e.g., a serving gateway (S-GW), a packet data network (PDN) gateway (P-GW), and a mobility management entity (MME)). When the communication system 100 is a 5G communication system (e.g., new radio (NR) system), the core network may include an access and mobility management function (AMF), a user plane function (UPF), a session management function (SMF), and the like.

The plurality of communication nodes 110 to 130 may support a communication protocol defined by the 3rd generation partnership project (3GPP) specifications (e.g., LTE communication protocol, LTE-A communication protocol, NR communication protocol, or the like). The plurality of communication nodes 110 to 130 may support code division multiple access (CDMA) technology, wideband CDMA (WCDMA) technology, time division multiple access (TDMA) technology, frequency division multiple access (FDMA) technology, orthogonal frequency division multiplexing (OFDM) technology, filtered OFDM technology, cyclic prefix OFDM (CP-OFDM) technology, discrete Fourier transform-spread-OFDM (DFT-s-OFDM) technology, orthogonal frequency division multiple access (OFDMA) technology, single carrier FDMA (SC-FDMA) technology, non-orthogonal multiple access (NOMA) technology, generalized frequency division multiplexing (GFDM) technology, filter band multi-carrier (FBMC) technology, universal filtered multi-carrier (UFMC) technology, space division multiple access (SDMA) technology, or the like. Each of the plurality of communication nodes may have the following structure.

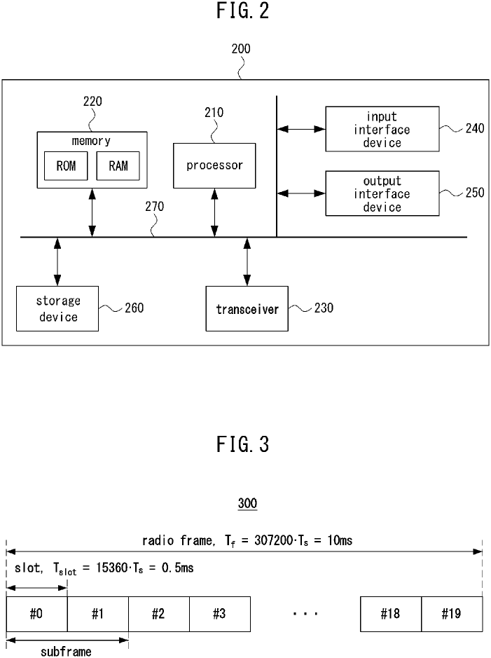

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), a evolved Node-B (eNB), a gNB, an advanced base station (ABS), a high reliability-base station (HR-BS), a base transceiver station (BTS), a radio base station, a radio transceiver, an access point, an access node, a radio access station (RAS), a mobile multihop relay-base station (MMR-BS), a relay station (RS), an advanced relay station (ARS), a high reliability-relay station (HR-RS), a home NodeB (HNB), a home eNodeB (HeNB), a road side unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, the communication system may support three types of frame structures. A type 1 frame structure may be applied to a frequency division duplex (FDD) communication system, a type 2 frame structure may be applied to a time division duplex (TDD) communication system, and a type 3 frame structure may be applied to an unlicensed band based communication system (e.g., a licensed assisted access (LAA) communication system).

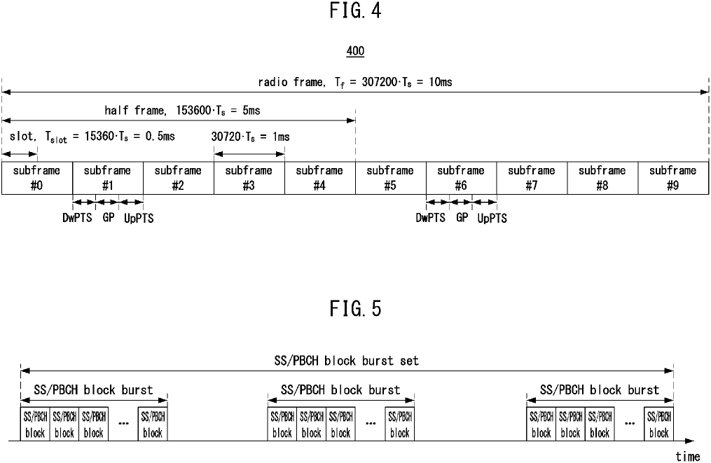

FIG. 3 is a conceptual diagram illustrating a first exemplary embodiment of a type 1 frame.

Referring to FIG. 3, a radio frame 300 may comprise 10 subframes, and a subframe may comprise 2 slots. Thus, the radio frame 300 may comprise 20 slots (e.g., slot #0, slot #1, slot #2, slot #3, ..., slot #18, and slot #19). The length T_{f} of the radio frame 300 may be 10 milliseconds (ms). The length of the subframe may be 1 ms, and the length Tₛₗₒₜ of a slot may be 0.5 ms. Here, Tₛ may indicate a sampling time, and may be 1/30,720,000s.

The slot may be composed of a plurality of OFDM symbols in the time domain, and may be composed of a plurality of resource blocks (RBs) in the frequency domain. The RB may be composed of a plurality of subcarriers in the frequency domain. The number of OFDM symbols constituting the slot may vary depending on configuration of a cyclic prefix (CP). The CP may be classified into a normal CP and an extended CP. If the normal CP is used, the slot may be composed of 7 OFDM symbols, in which case the subframe may be composed of 14 OFDM symbols. If the extended CP is used, the slot may be composed of 6 OFDM symbols, in which case the subframe may be composed of 12 OFDM symbols.

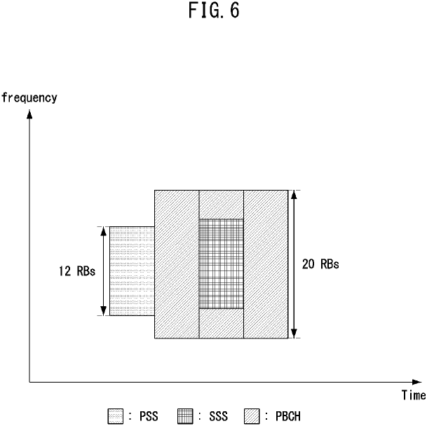

FIG. 4 is a conceptual diagram illustrating a first exemplary embodiment of a type 2 frame.

Referring to FIG. 4, a radio frame 400 may comprise two half frames, and a half frame may comprise 5 subframes. Thus, the radio frame 400 may comprise 10 subframes. The length T_{f} of the radio frame 400 may be 10 ms. The length of the half frame may be 5 ms. The length of the subframe may be 1 ms. Here, Tₛ may be 1/30,720,000s.

The radio frame 400 may include at least one downlink subframe, at least one uplink subframe, and a least one special subframe. Each of the downlink subframe and the uplink subframe may include two slots. The length Tₛₗₒₜ of a slot may be 0.5 ms. Among the subframes included in the radio frame 400, each of the subframe #1 and the subframe #6 may be a special subframe. For example, when a switching periodicity between downlink and uplink is 5 ms, the radio frame 400 may include 2 special subframes. Alternatively, the switching periodicity between downlink and uplink is 10 ms, the radio frame 400 may include one special subframe. The special subframe may include a downlink pilot time slot (DwPTS), a guard period (GP), and an uplink pilot time slot (UpPTS).

The downlink pilot time slot may be regarded as a downlink interval and may be used for cell search, time and frequency synchronization acquisition of the terminal, channel estimation, and the like. The guard period may be used for resolving interference problems of uplink data transmission caused by delay of downlink data reception. Also, the guard period may include a time required for switching from the downlink data reception operation to the uplink data transmission operation. The uplink pilot time slot may be used for uplink channel estimation, time and frequency synchronization acquisition, and the like. Transmission of a physical random access channel (PRACH) or a sounding reference signal (SRS) may be performed in the uplink pilot time slot.

The lengths of the downlink pilot time slot, the guard period, and the uplink pilot time slot included in the special subframe may be variably adjusted as needed. In addition, the number and position of each of the downlink subframe, the uplink subframe, and the special subframe included in the radio frame 400 may be changed as needed.

In the communication system, a transmission time interval (TTI) may be a basic time unit for transmitting coded data through a physical layer. A short TTI may be used to support low latency requirements in the communication system. The length of the short TTI may be less than 1 ms. The conventional TTI having a length of 1 ms may be referred to as a base TTI or a regular TTI. That is, the base TTI may be composed of one subframe. In order to support transmission on a base TTI basis, signals and channels may be configured on a subframe basis. For example, a cell-specific reference signal (CRS), a physical downlink control channel (PDCCH), a physical downlink shared channel (PDSCH), a physical uplink control channel (PUCCH), a physical uplink shared channel (PUSCH), and the like may exist in each subframe.

On the other hand, a synchronization signal (e.g., a primary synchronization signal (PSS) and a secondary synchronization signal (SSS)) may exist for every 5 subframes, and a physical broadcast channel (PBCH) may exist for every 10 subframes. Also, each radio frame may be identified by an SFN, and the SFN may be used for defining transmission of a signal (e.g., a paging signal, a reference signal for channel estimation, a signal for channel state information, etc.) longer than one radio frame. The periodicity of the SFN may be 1024.

In the LTE system, the PBCH may be a physical layer channel used for transmission of system information (e.g., master information block (MIB)). The PBCH may be transmitted every 10 subframes. That is, the transmission periodicity of the PBCH may be 10 ms, and the PBCH may be transmitted once in the radio frame. The same MIB may be transmitted during 4 consecutive radio frames, and after 4 consecutive radio frames, the MIB may be changed according to a situation of the LTE system. The transmission period for which the same MIB is transmitted may be referred to as a ‘PBCH TTI’, and the PBCH TTI may be 40 ms. That is, the MIB may be changed for each PBCH TTI.

The MIB may be composed of 40 bits. Among the 40 bits constituting the MIB, 3 bits may be used to indicate a system band, 3 bits may be used to indicate physical hybrid automatic repeat request (ARQ) indicator channel (PHICH) related information, 8 bits may be used to indicate an SFN, 10 bits may be configured as reserved bits, and 16 bits may be used for a cyclic redundancy check (CRC).

The SFN for identifying the radio frame may be composed of a total of 10 bits (B9 to B0), and the most significant bits (MSBs) 8 bits (B9 to B2) among the 10 bits may be indicated by the PBCH (i.e., MIB). The MSBs 8 bits (B9 to B2) of the SFN indicated by the PBCH (i.e., MIB) may be identical during 4 consecutive radio frames (i.e., PBCH TTI). The least significant bits (LSBs) 2 bits (B1 to B0) of the SFN may be changed during 4 consecutive radio frames (i.e., PBCH TTI), and may not be explicitly indicated by the PBCH (i.e., MIB). The LSBs (2 bits (B1 to B0)) of the SFN may be implicitly indicated by a scrambling sequence of the PBCH (hereinafter referred to as ‘PBCH scrambling sequence’).

A Gold sequence generated by being initialized by a cell ID may be used as the PBCH scrambling sequence, and the PBCH scrambling sequence may be initialized for each four consecutive radio frames (e.g., each PBCH TTI) based on an operation of ‘mod (SFN, 4)’. The PBCH transmitted in a radio frame corresponding to an SFN with LSBs 2 bits (B1 to B0) set to ‘00’ may be scrambled by the Gold sequence generated by being initialized by the cell ID. Thereafter, the Gold sequences generated according to the operation of ‘mod (SFN, 4)’ may be used to scramble the PBCH transmitted in the radio frames corresponding to SFNs with LSBs 2 bits (B1 to B0) set to ‘01’, ‘10’, and ‘11’.

Accordingly, the terminal having acquired the cell ID in the initial cell search process may identify the value of the LSBs 2 bits (B1 to B0) of the SFN (e.g., ‘00’, ‘01’, ‘10’, or ‘11’) based on the PBCH scramble sequence obtained in the decoding process for the PBCH (i.e., MIB). The terminal may use the LSBs 2 bits (B1 to B0) of the SFN obtained based on the PBCH scrambling sequence and the MSBs 8 bits (B9 to B2) of the SFN indicated by the PBCH (i.e., MIB) so as to identify the SFN (i.e., the entire bits B9 to B0 of the SFN).

The evolved mobile communication network after the LTE should satisfy technical requirements for supporting more diverse service scenarios as well as a high transmission rate, which has been a major concern in the prior arts. Recently, the ITU-R has defined key performance indicators (KPIs) and requirements for IMT-2020, the official name of 5G mobile communication, which are summarized as a high transmission rate (i.e., enhanced Mobile BroadBand (eMBB)), short transmission latency (i.e., Ultra-Reliable Low-Latency Communication (URLLC)), and massive terminal connectivity (i.e., massive Machine Type Communication (mMTC)). According to the ITU-R projected schedule, it aims to allocate frequencies for IMT-2020 in 2019 and complete international standard approvals by 2020.

The 3GPP is developing a new radio access technology (RAT)-based 5G standard that meets the IMT-2020 requirements. According to the definition of the 3GPP, the new RAT is a radio access technology that does not have backward compatibility with the existing 3GPP RAT. The new radio communication system after the LTE, which adopts such the RAT, will be referred to as new radio (NR) in the present disclosure.

One of characteristics of the NR different from the CDMA and LTE, which are the conventional 3GPP systems, is that it utilizes a wide range of frequency bands to increase transmission capacity. In this regard, the WRC-19 agenda hosted by the ITU was to review 24.25 to 86 GHz frequency bands as candidate frequency bands for IMT-2020. In the 3GPP, bands from a sub-1 GHz band to a 100 GHz band are considered as candidate NR bands.

As a waveform technology for the NR, Orthogonal Frequency Division Multiplexing (OFDM), Filtered OFDM, Generalized Frequency Division Multiplexing (GFDM), Filter Bank Multi-Carrier (FBMC), Universal Filtered Multi-Carrier (UFM|C), and/or the like are discussed as candidate technologies. Although each has pros and cons, Cyclic Prefix (CP)-based OFDM and Single Carrier-Frequency Division Multiple Access (SC-FDMA) are still effective schemes for the 5G system, due to their relatively low implementation complexity at a transceiver and Multiple-Input Multiple-Output (MIMO) scalability. However, in order to flexibly support various 5G usage scenarios, a method of simultaneously accommodating different waveform parameters within one carrier without guard bands may be considered, and for this case, the Filtered OFDM or GFDM having a low out-of-band Emission (OOB) may be suitable.

In the present disclosure, for convenience of description, it is assumed that the CP-based OFDM is used as a waveform technology for radio access. However, this is only for convenience of description, and various exemplary embodiments of the present disclosure are not limited to a specific waveform technology. In general, the category of CP-based OFDM technology includes the Filtered OFDM or Spread Spectrum OFDM (e.g., DFT-spread OFDM) technology.

The subcarrier spacing of the communication system (e.g., OFDM-based communication system) may be determined based on a carrier frequency offset (CFO) and the like. The CFO may be generated by a Doppler effect, a phase drift, or the like, and may increase in proportion to an operation frequency. Therefore, in order to prevent the performance degradation of the communication system due to the CFO, the subcarrier spacing may increase in proportion to the operation frequency. On the other hand, as the subcarrier spacing increases, a CP overhead may increase. Therefore, the subcarrier spacing may be configured based on a channel characteristic, a radio frequency (RF) characteristic, etc. according to a frequency band.

Various numerologies are being considered in the NR system. For example, the subcarrier spacing of the communication system may be configured to 15 kHz, 30 kHz, 60 kHz, or 120 kHz. The subcarrier spacing of the LTE system may be 15 kHz, and the subcarrier spacing of the NR system may be 1, 2, 4, or 8 times the conventional subcarrier spacing of 15 kHz. If the subcarrier spacing increases by exponentiation units of 2 of the conventional subcarrier spacing, the frame structure can be easily designed.

The communication system may support a wide frequency band (e.g., several hundred MHz to tens of GHz). Since the diffraction characteristic and the reflection characteristic of the radio wave are poor in a high frequency band, a propagation loss (e.g., path loss, reflection loss, and the like) in a high frequency band may be larger than a propagation loss in a low frequency band. Therefore, a cell coverage of a communication system supporting a high frequency band may be smaller than a cell coverage of a communication system supporting a low frequency band. In order to solve such the problem, a beamforming scheme based on a plurality of antenna elements may be used to increase the cell coverage in the communication system supporting a high frequency band.

The beamforming scheme may include a digital beamforming scheme, an analog beamforming scheme, a hybrid beamforming scheme, and the like. In the communication system using the digital beamforming scheme, a beamforming gain may be obtained using a plurality of RF paths based on a digital precoder or a codebook. In the communication system using the analog beamforming scheme, a beamforming gain may be obtained using analog RF devices (e.g., phase shifter, power amplifier (PA), variable gain amplifier (VGA), and the like) and an antenna array.

Because of the need for expensive digital to analog converters (DACs) or analog to digital converters (ADCs) for digital beamforming schemes and transceiver units corresponding to the number of antenna elements, the complexity of antenna implementation may be increased to increase the beamforming gain. In case of the communication system using the analog beamforming scheme, since a plurality of antenna elements are connected to one transceiver unit through phase shifters, the complexity of the antenna implementation may not increase greatly even if the beamforming gain is increased. However, the beamforming performance of the communication system using the analog beamforming scheme may be lower than the beamforming performance of the communication system using the digital beamforming scheme. Further, in the communication system using the analog beamforming scheme, since the phase shifter is adjusted in the time domain, frequency resources may not be efficiently used. Therefore, a hybrid beam forming scheme, which is a combination of the digital scheme and the analog scheme, may be used.

When the cell coverage is increased by the use of the beamforming scheme, common control channels and common signals (e.g., reference signal and synchronization signal) for all terminals belonging to the cell coverage as well as control channels and data channels for each terminal may also be transmitted based on the beamforming scheme. In the case of transmitting a common control channel or signal to all terminals while increasing the cell coverage by applying beamforming, it may be difficult to transmit the common control channel or signal to the entire cell coverage by single transmission, and the common control channel or signal should be transmitted several times over multiple beams. A scheme of transmitting a channel or signal several times through different beams over a period of time may be referred to as beam sweeping. When a common control channel or signal is transmitted by applying beamforming, such the beam sweeping operation is absolutely necessary.

A terminal desiring to access the system may acquire downlink frequency/time synchronization and cell ID information using a synchronization signal, acquire uplink synchronization through a random access procedure, and form a radio link. In this case, in the NR system, a synchronization signal/physical broadcast channel (SS/PBCH) block may also be transmitted in a beam sweeping scheme. The SS/PBCH block may be composed of a PSS, an SSS, a PBCH, and the like. In the SS/PBCH block, the PSS, the SSS, and the PBCH may be configured in a time division multiplexing (TDM) manner. The SS/PBCH block may be referred also to as an ‘SS block (SSB)’. One SS/PBCH block may be transmitted using N consecutive OFDM symbols. Here, N may be an integer equal to or greater than 4. The base station may periodically transmit the SS/PBCH block, and the terminal may acquire frequency/time synchronization, a cell ID, system information, and the like based on the SS/PBCH block received from the base station. The SS/PBCH block may be transmitted as follows.

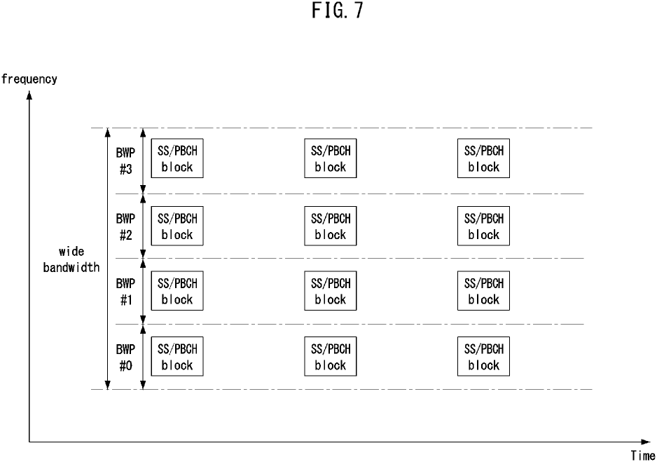

FIG. 5 is a conceptual diagram illustrating a first exemplary embodiment of a transmission method of SS/PBCH block in a communication system.

Referring to FIG. 5, one or more SS/PBCH blocks may be transmitted in a beam sweeping scheme within an SS/PBCH block burst set. Up to L SS/PBCH blocks may be transmitted within one SS/PBCH block burst set. L may be an integer equal to or greater than 2, and may be defined in the 3GPP standard. Depending on a region of a system frequency, L may vary. Within the SS/PBCH block burst set, the SS/PBCH blocks may be located consecutively or distributedly. The consecutive SS/PBCH blocks may be referred to as an ‘SS/PBCH block burst’. The SS/PBCH block burst set may be repeated periodically, and system information (e.g., MIB) transmitted through the PBCHs of the SS/PBCH blocks within the SS/PBCH block burst set may be the same. An index of the SS/PBCH block, an index of the SS/PBCH block burst, an index of an OFDM symbol, an index of a slot, and the like may be indicated explicitly or implicitly by the PBCH.

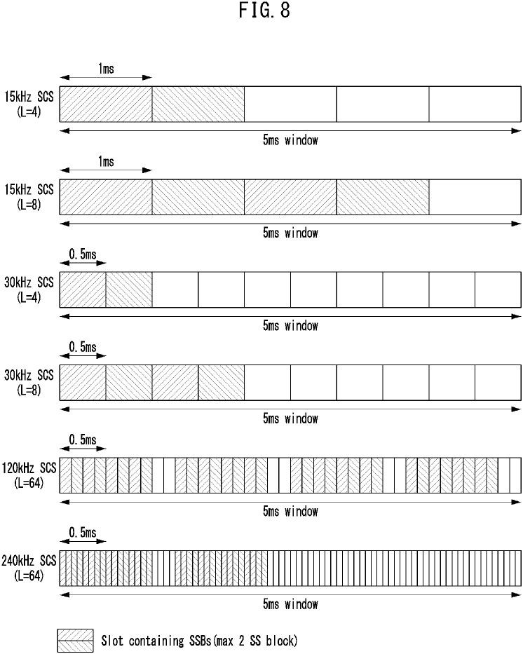

FIG. 6 is a conceptual diagram illustrating a first exemplary embodiment of an SS/PBCH block in a communication system.

Referring to FIG. 6, signals and a channel are arranged within one SS/PBCH block in the order of ‘PSS➔PBCH➔SSS➔PBCH’. The PSS, SSS, and PBCH within the SS/PBCH block may be configured in a TDM scheme. In a symbol where the SSS is located, the PBCH may be located in frequency resources above the SSS and frequency resources below the SSS. That is, the PBCH may be transmitted in both end bands adjacent to the frequency band in which the SSS is transmitted. When the maximum number of SS/PBCH blocks is 8 in the sub 6 GHz frequency band, an SS/PBCH block index may be identified based on a demodulation reference signal used for demodulating the PBCH (hereinafter, referred to as ‘PBCH DMRS’). When the maximum number of SSBs is 64 in the over 6 GHz frequency band, LSB 3 bits of 6 bits representing the SS/PBCH block index may be identified based on the PBCH DMRS, and the remaining MSB 3 bits may be identified based on a payload of the PBCH.

The maximum system bandwidth that can be supported in the NR system may be 400 MHz. The size of the maximum bandwidth that can be supported by the terminal may vary depending on the capability of the terminal. Therefore, the terminal may perform an initial access procedure (e.g., initial connection procedure) by using some of the system bandwidth of the NR system supporting a wide band. In order to support access procedures of terminals supporting various sizes of bandwidths, SS/PBCH blocks may be multiplexed in the frequency domain within the system bandwidth of the NR system supporting a wide band. In this case, the SS/PBCH blocks may be transmitted as follows.

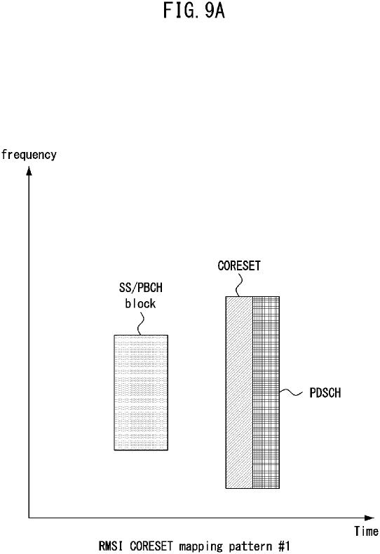

FIG. 7 is a conceptual diagram illustrating a second exemplary embodiment of a method of transmitting SS/PBCH blocks in a communication system.

Referring to FIG. 7, a wideband component carrier (CC) may include a plurality of bandwidth parts (BWPs). For example, the wideband CC may include 4 BWPs. The base station may transmit SS/PBCH blocks in the respective BWPs #0 to #3 belonging to the wideband CC. The terminal may receive the SS/PBCH block(s) from one or more BWPs of the BWPs #0 to #3, and may perform an initial access procedure using the received SS/PBCH block.

After detecting the SS/PBCH block, the terminal may acquire system information (e.g., remaining minimum system information (RMSI)), and may perform a cell access procedure based on the system information. The RMSI may be transmitted on a PDSCH scheduled by a PDCCH. Configuration information of a control resource set (CORESET) in which the PDCCH including scheduling information of the PDSCH through which the RMSI is transmitted may be transmitted on a PBCH within the SS/PBCH block. A plurality of SS/PBCH blocks may be transmitted in the entire system band, and one or more SS/PBCH blocks among the plurality of SS/PBCH blocks may be SS/PBCH block(s) associated with the RMSI. The remaining SS/PBCH blocks may not be associated with the RMSI. The SS/PBCH block associated with the RMSI may be defined as a ‘cell defining SS/PBCH block’. The terminal may perform a cell search procedure and an initial access procedure by using the cell-defining SS/PBCH block. The SS/PBCH block not associated with the RMSI may be used for a synchronization procedure and/or a measurement procedure in the corresponding BWP. The BWP(s) through which the SS/PBCH block is transmitted may be limited to one or more BWPs within a wide bandwidth.

The RMSI may be obtained by performing an operation to obtain configuration information of a CORESET from the SS/PBCH block (e.g., PBCH), an operation of detecting a PDCCH based on the configuration information of the CORESET, an operation to obtain scheduling information of a PDSCH from the PDCCH, and an operation to receive the RMSI through the PDSCH. A transmission resource of the PDCCH may be configured by the configuration information of the CORESET. A mapping patter of the RMSI CORESET pattern may be defined as follows. The RMSI CORESET may be a CORESET used for transmission and reception of the RMSI.

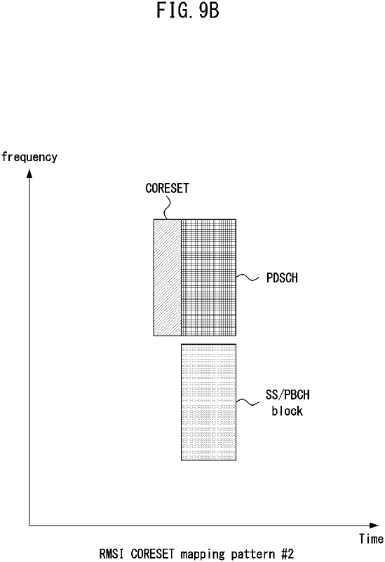

FIG. 8 is a conceptual diagram for describing time domain transmission positions of SSBs according to a subcarrier spacing and L.

The time domain positions where SSB(s) are transmitted may be differently defined according to a subcarrier spacing and a value of L. Short UL transmission such as uplink control information (UCI) may be performed in symbol(s) where SSB(s) are not transmitted within one slot. In transmission of SSB(s) having a large subcarrier spacing (e.g., 120 kHz or 240 kHz SCS), a gap may be configured in the middle of consecutive slots containing the SSB(s) so that long UL transmission such as URLLC traffic can be performed at least every 1 ms.

As in the example of FIG. 8, a gap for UL transmission may be configured after 8 slots containing SSBs having 120 kHz subcarrier spacing, and a gap for UL transmission may be configured after 16 slots containing SSBs having 240 kHz subcarrier spacing.

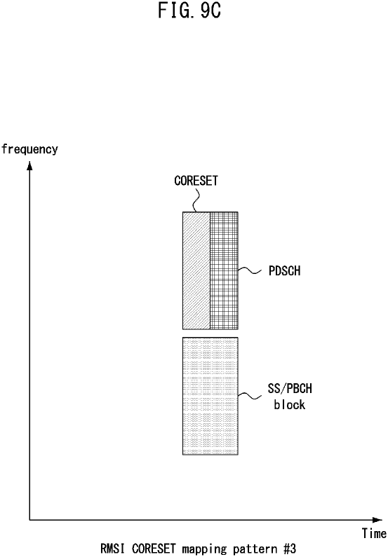

FIG. 9A is a conceptual diagram illustrating an RMSI CORESET mapping pattern #1 in a communication system, FIG. 9B is a conceptual diagram illustrating an RMSI CORESET mapping pattern #2 in a communication system, and FIG. 9C is a conceptual diagram illustrating an RMSI CORESET mapping pattern #3 in a communication system.

Referring to FIGS. 9A to 9C, one RMSI CORESET mapping pattern among the RMSI CORESET mapping patterns #1 to #3 may be used, and a detailed configuration according to the one RMSI CORESET mapping pattern may be determined. In the RMSI CORESET mapping pattern #1, the SS/PBCH block, the CORESET (i.e., RMSI CORESET), and the PDSCH (i.e., RMSI PDSCH) may be configured in a TDM scheme. The RMSI PDSCH may mean the PDSCH through which the RMSI is transmitted. In the RMSI CORESET mapping pattern #2, the CORESET (i.e., RMSI CORESET) and the PDSCH (i.e., RMSI PDSCH) may be configured in a TDM scheme, and the PDSCH (i.e., RMSI PDSCH) and the SS/PBCH block may be configured in a frequency division multiplexing (FDM) scheme. In the RMSI CORESET mapping pattern #3, the CORESET (i.e., RMSI CORESET) and the PDSCH (i.e., RMSI PDSCH) may be configured in a TDM scheme, and the CORESET (i.e., RMSI CORESET) and the PDSCH (i.e., RMSI PDSCH) may be multiplexed with the SS/PBCH block in a FDM scheme.

In the frequency band of 6 GHz or below, only the RMSI CORESET mapping pattern #1 may be used. In the frequency band of 6 GHz or above, all of the RMSI CORESET mapping patterns #1, #2, and #3 may be used. The numerology of the SS/PBCH block may be different from that of the RMSI CORESET and the RMSI PDSCH. Here, the numerology may be a subcarrier spacing. In the RMSI CORESET mapping pattern #1, a combination of all numerologies may be used. In the RMSI CORESET mapping pattern #2, a combination of numerologies (120 kHz, 60 kHz) or (240 kHz, 120 kHz) may be used for the SS/PBCH block and the RMSI CORESET/PDSCH. In the RMSI CORESET mapping pattern #3, a combination of numerologies (120 kHz, 120 kHz) may be used for the SS/PBCH block and the RMSI CORESET/PDSCH.

One RMSI CORESET mapping pattern may be selected from the RMSI CORESET mapping patterns #1 to #3 according to the combination of the numerology of the SS/PBCH block and the numerology of the RMSI CORESET/PDSCH. The configuration information of the RMSI CORESET may include Table A and Table B. Table A may represent the number of resource blocks (RBs) of the RMSI CORESET, the number of symbols of the RMSI CORESET, and an offset between an RB (e.g., starting RB or ending RB) of the SS/PBCH block and an RB (e.g., starting RB or ending RB) of the RMSI CORESET. Table B may represent the number of search space sets per slot, an offset of the RMSI CORESET, and an OFDM symbol index in each of the RMSI CORESET mapping patterns. Table B may represent information for configuring a monitoring occasion of the RMSI PDCCH. Each of Table A and Table B may be composed of a plurality of sub-tables. For example, Table A may include sub-tables 13-1 to 13-8 defined in the technical specification (TS) 38.213, and Table B may include sub-tables 13-9 to 13-13 defined in the TS 38.213. The size of each of Table A and Table B may be 4 bits.

In the NR system, a PDSCH may be mapped to the time domain according to a PDSCH mapping type A or a PDSCH mapping type B. The PDSCH mapping types A and B may be defined as Table 2 below.

TABLE 1

| PDSCH mapping type | Normal CP | | | Extended CP | | |
|---|---|---|---|---|---|---|
| | S | L | S+L | S | L | S+L |
| Type A | {0,1,2,3} (Note 1) | {3,...,14} | {3,...,14} | {0,1,2,3} (Note 1) | {3,...,12} | {3,...,12} |
| Type B | {0,...,12} | {2,4,7} | {2,...,14} | {0,...,10} | {2,4,6} | {2,...,12} |

Note 1: S=3 is applicable only if dmrs-TypeA-Position = 3

The type A (i.e., PDSCH mapping type A) may be slot-based transmission. When the type A is used, a position of a start symbol of a PDSCH may be configured to one of {0, 1, 2, 3}. When the type A and a normal CP are used, the number of symbols constituting the PDSCH (e.g., the duration of the PDSCH) may be configured to one of 3 to 14 within a range not exceeding a slot boundary. The type B (i.e., PDSCH mapping type B) may be non-slot-based transmission. When the type B is used, a position of a start symbol of a PDSCH may be configured to one of 0 to 12. When the type B and the normal CP are used, the number of symbols constituting the PDSCH (e.g., the duration of the PDSCH) may be configured to one of {2, 4, 7} within a range not exceeding a slot boundary. A DMRS (hereinafter, referred to as ‘PDSCH DMRS’) for demodulation of the PDSCH (e.g., data) may be determined by a value of ID indicating the PDSCH mapping type (e.g., type A or type B) and the length. The ID may be defined differently according to the PDSCH mapping type.

As NR phase 1 standardization is completed in releas-15 and NR phase 2 standardization begins in release-16, new features of the NR system are being discussed. One of the representative features is NR-Unlicensed (U). The NR-U is a technology to support operations in an unlicensed spectrum used for purposes such as Wi-Fi to increase network capacity by increasing utilization of limited frequency resources. For such the operations in an unlicensed spectrum, standardization started with the LTE-Licensed-Assisted Access (LAA) technology from Release-13, and has continued to evolve through release-14 LTE-Enhanced LAA (eLAA) and releas-15 LTE-Further Enhanced LAA (FeLAA). In the NR, standardization work is in progress as a work item (WI) in release-16 after a study item (SI) for the NR-U.

In the NR-U system, the terminal may determine whether a signal is transmitted from a base station based on a discovery reference signal (DRS) received from the corresponding base station in the same manner as in the general NR system. In the NR-U system in a Stand-Alone (SA) mode, the terminal may acquire synchronization and/or system information based on the DRS. In the NR-U system, the DRS may be transmitted according to a regulation of the unlicensed band (e.g., transmission band, transmission power, transmission time, etc.). For example, according to Occupied Channel Bandwidth (OCB) regulations, signals may be configured and/or transmitted to occupy 80% of the total channel bandwidth (e.g., 20 MHz).

In the NR-U system, a communication node (e.g., base station, terminal) may perform a Listen Before Talk (LBT) procedure before transmitting a signal and/or a channel for coexistence with another system. The signal may be a synchronization signal, a reference signal (e.g., DRS, DMRS, channel state information (CSI)-RS, phase tracking (PT)-RS, sounding reference signal (SRS)), or the like. The channel may be a downlink channel, an uplink channel, a sidelink channel, or the like. In exemplary embodiments, a signal may mean the ‘signal’, the ‘channel’, or the ‘signal and channel’. The LBT procedure may be an operation for checking whether a signal is transmitted by another communication node. If it is determined by the LBT procedure that there is no transmission signal (e.g., when the LBT procedure is successful), the communication node may transmit a signal in the unlicensed band. If it is determined by the LBT procedure that a transmission signal exists (e.g., when the LBT fails), the communication node may not be able to transmit a signal in the unlicensed band. The communication node may perform a LBT procedure according to one of various categories before transmission of a signal. The category of LBT may vary depending on the type of the transmission signal.

Another one of the representative features in release-16 phase 2 is NR-Vehicular-to-Everything (V2X). The V2X is a technology that supports communications in various scenarios such as vehicle-to-vehicle, vehicle and infrastructure, vehicle and pedestrian based on LTE Device to Device (D2D) communication. A lot of discussion for the V2X communication has been made in the LTE system, and it continues to develop even now. In the NR, with the start of release-16, discussion on the NR V2X has been started.

The NR V2X communication (e.g., sidelink communication) may be performed according to three transmission schemes (e.g., unicast scheme, broadcast scheme, groupcast scheme). When the unicast scheme is used, a PC5-RRC connection may be established between a first terminal (e.g. transmitting terminal that transmits data) and a second terminal (e.g., receiving terminal that receives data), and the PC5-RRC connection may refer to a logical connection for a pair between a source ID of the first terminal and a destination ID of the second terminal. The first terminal may transmit data (e.g., sidelink data) to the second terminal. When the broadcast scheme is used, the first terminal may transmit data to all terminals. When the groupcast scheme is used, the first terminal may transmit data to a group (e.g., groupcast group) composed of a plurality of terminals.

When the unicast scheme is used, the second terminal may transmit feedback information (e.g., acknowledgment (ACK) or negative ACK (NACK)) to the first terminal in response to data received from the first terminal. In the exemplary embodiments below, the feedback information may be referred to as a ‘HARQ-ACK’, ‘feedback signal’, a ‘physical sidelink feedback channel (PSFCH) signal’, or the like. When ACK is received from the second terminal, the first terminal may determine that the data has been successfully received at the second terminal. When NACK is received from the second terminal, the first terminal may determine that the second terminal has failed to receive the data. In this case, the first terminal may transmit additional information to the second terminal based on an HARQ scheme. Alternatively, the first terminal may improve a reception probability of the data at the second terminal by retransmitting the same data to the second terminal.

When the broadcast scheme is used, a procedure for transmitting feedback information for data may not be performed. For example, system information may be transmitted in the broadcast scheme, and the terminal may not transmit feedback information for the system information to the base station. Therefore, the base station may not identify whether the system information has been successfully received at the terminal. To solve this problem, the base station may periodically broadcast the system information.

When the groupcast scheme is used, a procedure for transmitting feedback information for data may not be performed. For example, necessary information may be periodically transmitted in the groupcast scheme, without the procedure for transmitting feedback information. However, when the candidates of terminals participating in the groupcast scheme-based communication and/or the number of the terminals participating in that is limited, and the data transmitted in the groupcast scheme is data that should be received within a preconfigured time (e.g., data sensitive to delay), it may be necessary to transmit feedback information also in the groupcast sidelink communication. The groupcast sidelink communication may mean sidelink communication performed in the groupcast scheme. When the feedback information transmission procedure is performed in the groupcast sidelink communication, data can be transmitted and received efficiently and reliably.

In the groupcast sidelink communication, two HARQ-ACK feedback schemes (i.e., transmission procedures of feedback information) may be supported. When the number of receiving terminals in a sidelink group is large and a service scenario 1 is supported, some receiving terminals belonging to a specific range within the sidelink group may transmit NACK through a PSFCH when data reception fails. This scheme may be a groupcast HARQ-ACK feedback option 1. In the service scenario 1, instead of all the receiving terminals in the sidelink group, it may be allowed for some receiving terminals belonging to a specific range to perform reception in a best-effort manner. The service scenario 1 may be an extended sensor scenario in which some receiving terminals belonging to a specific range need to receive the same sensor information from a transmitting terminal. In exemplary embodiments, the transmitting terminal may refer to a terminal transmitting data, and the receiving terminal may refer to a terminal receiving data.

When the number of receiving terminals in the sidelink group is limited and a service scenario 2 is supported, each of all the receiving terminals belonging to the sidelink group may report HARQ-ACK for data individually through a separate PSFCH. This scheme may be a groupcast HARQ-ACK feedback option 2. In the service scenario 2, since PSFCH resources are sufficient, the transmitting terminal may perform monitoring on HARQ-ACK feedbacks of all the receiving terminals belonging to the sidelink group, and data reception may be guaranteed at all the receiving terminals belonging to the sidelink group. Whether or not the ACK/NACK feedback procedure is applied to each of all the transmission schemes may be statically or semi-statically configured through system information and UE-specific RRC signaling, and dynamic configuration thereof may also be possible through control information.

In sidelink communication, ACK/NACK feedback information may be transmitted on a PSFCH. The PSFCH may be a channel used by a sidelink receiving terminal to report ACK/NACK information according to whether a PSSCH is successfully received to a sidelink transmitting terminal. A resource region for PSFCH transmission may be configured within a specific resource pool.

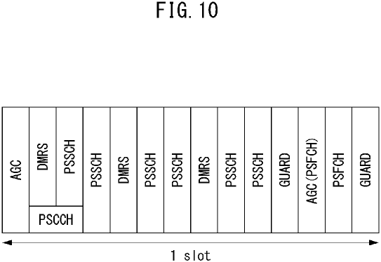

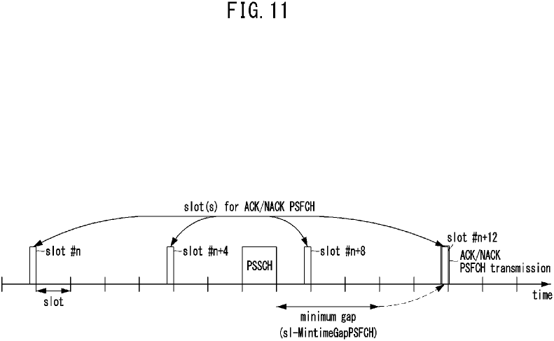

FIG. 10 is a conceptual diagram for describing an example of PSFCH configuration within one slot, and FIG. 11 is a conceptual diagram for describing an example of configuring PSFCH resources according to a PSFCH transmission periodicity.

Referring to FIG. 11, a terminal may transmit a PSFCH in a slot #n+12, which is a slot capable of transmitting a PSFCH after a previously set sl-MinTimeGapPSFCH (e.g., 3 slots) from a time (e.g., slot) when a PSSCH is received.

For example, the PSFCHs may be configured with a periodicity of 1, 2, or 4 logical slots. Referring to FIG. 10, in a slot in which PSFCH transmission is possible, the PSFCH may be repeatedly transmitted over two OFDM symbols. The first symbol of the two OFDM symbols in which the PSFCH is transmitted may be used for AGC purpose for adjusting a PSFCH reception power level.

In corresponding symbols, the PSFCH may be transmitted within a frequency resource region configured in advance by system information. In this case, the frequency resource region used for PSFCH transmission may be signaled in form of a bitmap for the corresponding resource pool. The receiving terminal may implicitly select the frequency resource region in which the PSFCH is to be transmitted based on a slot index and a subchannel index of slot(s) and subchannel(s) in which the PSSCH is received. In addition, an index of a PSFCH resource to transmit the PSFCH may be implicitly selected based on a physical layer source ID and a member ID from among PSFCH resources that can be multiplexed in resource block(s) (RB(s)) using cyclic shifts of a PSFCH sequence within the frequency resource region. In this case, the member ID may be used only in the groupcast HARQ ACK/NACK feedback option 2 described above, and in other cases, the member ID may be set to 0. A transmission time of the PSFCH may be determined as the first slot capable of transmitting the PSFCH occurring after a predetermined time (i.e., sl-MinTimeGapPSFCH) from a reception time of the corresponding PSSCH. sl-MinTimeGapPSFCH may be set in advance to 2 slots or 3 slots, considering a time required for processing the received PSSCH and a time required for preparing ACK/NACK information depending on whether or not the PSSCH is successfully received.

In addition, data reliability at the receiving terminal may be improved by appropriately adjusting a transmit power of the transmitting terminal according to a transmission environment. Interference to other terminals may be mitigated by appropriately adjusting the transmit power of the transmitting terminal. Energy efficiency can be improved by reducing unnecessary transmit power. A power control scheme may be classified into an open-loop power control scheme and a closed-loop power control scheme. In the open-loop power control scheme, the transmitting terminal may determine the transmit power in consideration of configuration, a measured environment, etc. In the closed-loop power control scheme, the transmitting terminal may determine the transmit power based on a transmit power control (TPC) command received from the receiving terminal.

It may be difficult due to various causes including a multipath fading channel, interference, and the like to predict a received signal strength at the receiving terminal. Accordingly, the receiving terminal may adjust a receive power level (e.g., receive power range) by performing an automatic gain control (AGC) operation to prevent a quantization error of the received signal and maintain a proper receive power. In the communication system, the terminal may perform the AGC operation using a reference signal received from the base station. However, in the sidelink communication (e.g., V2X communication), the reference signal may not be transmitted from the base station. That is, in the sidelink communication, communication between terminals may be performed without the base station. Therefore, it may be difficult to perform the AGC operation in the sidelink communication. In the sidelink communication, the transmitting terminal may first transmit a signal (e.g., reference signal) to the receiving terminal before transmitting data, and the receiving terminal may adjust a receive power range (e.g., receive power level) by performing an AGC operation based on the signal received from the transmitting terminal. Thereafter, the transmitting terminal may transmit sidelink data to the receiving terminal. The signal used for the AGC operation may be a signal duplicated from a signal to be transmitted later or a signal preconfigured between the terminals.

A time period required for the ACG operation may be 15 µs. When a subcarrier spacing of 15 kHz is used in the NR system, a time period (e.g., length) of one symbol (e.g., OFDM symbol) may be 66.7 µs. When a subcarrier spacing of 30 kHz is used in the NR system, a time period of one symbol (e.g., OFDM symbol) may be 33.3 µs. In the following exemplary embodiments, a symbol may mean an OFDM symbol. That is, a time period of one symbol may be twice or more than a time period required for the ACG operation.

For sidelink communication, it may be necessary to transmit a data channel for data transmission and a control channel including scheduling information for data resource allocation. In sidelink communication, the data channel may be a physical sidelink shared channel (PSSCH), and the control channel may be a physical sidelink control channel (PSCCH). The data channel and the control channel may be multiplexed in a resource domain (e.g., time and frequency resource domains).

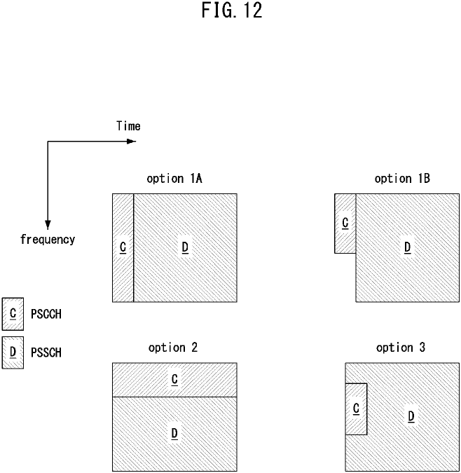

FIG. 12 is a conceptual diagram illustrating exemplary embodiments of a method for multiplexing a control channel and a data channel in sidelink communication.

Referring to FIG. 12, sidelink communication may support an option 1A, an option 1B, an option 2, and an option 3. When the option 1A and/or the option 1B is supported, a control channel and a data channel may be multiplexed in the time domain. When the option 2 is supported, a control channel and a data channel may be multiplexed in the frequency domain. When the option 3 is supported, a control channel and a data channel may be multiplexed in the time and frequency domains. The sidelink communication may basically support the option 3.

In the sidelink communication (e.g., NR-V2X sidelink communication), a basic unit of resource configuration may be a subchannel. The subchannel may be defined with time and frequency resources. For example, the subchannel may be composed of a plurality of symbols (e.g., OFDM symbols) in the time domain, and may be composed of a plurality of resource blocks (RBs) in the frequency domain. The subchannel may be referred to as an RB set. In the subchannel, a data channel and a control channel may be multiplexed based on the option 3.

In the sidelink communication (e.g., NR-V2X sidelink communication), transmission resources may be allocated based on a mode 1 or a mode 2. When the mode 1 is used, a base station may allocate sidelink resource(s) for data transmission within a resource pool to a transmitting terminal, and the transmitting terminal may transmit data to a receiving terminal using the sidelink resource(s) allocated by the base station. Here, the transmitting terminal may be a terminal that transmits data in sidelink communication, and the receiving terminal may be a terminal that receives the data in sidelink communication.

When the mode 2 is used, a transmitting terminal may autonomously select sidelink resource(s) to be used for data transmission by performing a resource sensing operation and/or a resource selection operation within a resource pool. The base station may configure the resource pool for the mode 1 and the resource pool for the mode 2 to the terminal(s). The resource pool for the mode 1 may be configured independently from the resource pool for the mode 2. Alternatively, a common resource pool may be configured for the mode 1 and the mode 2.

When the mode 1 is used, the base station may schedule a resource used for sidelink data transmission to the transmitting terminal, and the transmitting terminal may transmit sidelink data to the receiving terminal by using the resource scheduled by the base station. Therefore, a resource conflict between terminals may be prevented. When the mode 2 is used, the transmitting terminal may select an arbitrary resource by performing a resource sensing operation and/or resource selection operation, and may transmit sidelink data by using the selected arbitrary resource. Since the above-described procedure is performed based on an individual resource sensing operation and/or resource selection operation of each transmitting terminal, a conflict between selected resources may occur.

When a UL carrier rather than an independent (or dedicated) SL carrier is used in sidelink communication, some of UL resources may be configured and used as SL resources through SL resource pool configuration. A bitmap of a specific length may be repeatedly applied to slots other than slots in which at least X or more UL symbols are not configured and slots in which a sidelink SSB (S-SSB) is transmitted among slots according to a specific periodicity. That is, only slots indicated as ‘1’ in the bitmap may be used as SL resources. For example, assuming that a 15 kHz SCS is used and X or more UL symbols are configured in all slots, there may be 10,240 available slots corresponding to one direct frame number (DFN). Assuming that the S-SSB is transmitted at a periodicity of 160 ms, when there are two slots used for S-SSB transmission within one S-SSB period, the number of slots used for S-SSB transmission among 10,240 slots corresponding to one DFN may be 128. When the bitmap for SL time resource configuration is composed of 10 bits, if the bitmap is repeatedly applied to the remaining slots excluding 128 slots used for S-SSB transmission among 10,240 slots, exclusion of additional reserved slots may be required. For example, if two reserved slots are additionally excluded, 10,110 (= 10240-128-2) slots may remain, so that the 10-bit bitmap may be repeatedly applied 1,011 times to 10,110 slots. In this case, assuming that the bitmap is configured as ‘1111000000’, only slots indicated as ‘1’ in the bitmap can be used as SL resources, and finally, a total of 4,044 slots corresponding to one DFN may be configured as SL resources. That is, 4,044 slots among 10,240 slots corresponding to one DFN may be used for SL communication through the SL resource pool configuration.

The sidelink communication system supporting Release-16 may be designed for terminals (e.g., vehicle-mounted terminals, vehicle UEs (V-UEs)) that do not have restrictions on battery capacity. Therefore, a power saving issue may not be greatly considered in resource sensing/selection operations for such the terminals. However, in order to perform sidelink communication with terminals having restrictions on battery capacity in the sidelink communication system supporting Release-17 (e.g., a terminal carried by a pedestrian, a terminal mounted on a bicycle, a terminal mounted on a motorcycle, a pedestrian UE (P-UE)), power saving methods will be required. In the present disclosure, a ‘V-UE’ may refer to a terminal that has no significant restrictions on battery capacity, a ‘P-UE’ may refer to a terminal with restrictions on battery capacity, and a ‘resource sensing/selection operation’ may refer to a resource sensing operation and/or a resource selection operation. The resource sensing operation may refer to a partial sensing operation or a full sensing operation. The resource selection operation may refer to a random selection operation. In addition, in the present disclosure, an ‘operation of a terminal’ may be interpreted as an ‘operation of a V-UE’ and/or ‘operation of a P-UE’.

For power saving in the LTE V2X, a partial sensing operation and/or a random selection operation has been introduced. When the partial sensing operation is supported, the terminal may perform resource sensing operations in partial periods instead of an entire period within a sensing window, and may select a resource based on a result of the partial sensing operation. The partial sensing operation may be used for periodic data transmission/reception. The terminal may randomly select candidate slots in consideration of the preset minimum number of slots within a resource selection period (e.g., resource selection window, sensing window) defined in the LTE V2X supporting Release-14, and may perform the partial sensing operation based on the selected candidate slots according to a periodicity of k × 100 ms. The base station may inform the terminal of a value of k. The value of k may be signaled by a bitmap, and the bitmap may consist of 10 bits. The value of k may be determined according to a position of a corresponding bit having a specific value in the bitmap. For example, bits included in the bitmap may correspond to 1 to 10 in the order of ‘most significant bit (MSB) → least significant bit (LSB)’. For example, the first bit in the bitmap may indicate 1 (i.e., k=1), the second bit in the bitmap may indicate 2 (i.e., k=2), and the tenth bit in the bitmap may indicate 10 (i.e., k=10).

The terminal may determine a value corresponding to a bit set to ‘1’ in the bitmap as the value of k, and may determine (e.g., set) a periodicity of the partial sensing operation based on k. When the MSB of the bitmap is set to ‘1’, a periodicity of the partial sensing operation may be 100 ms (i.e., 1×100 ms). When the second MSB of the bitmap is set to ‘1’, a periodicity of the partial sensing operation may be 200 ms (i.e., 2×100 ms). When the LSB of the bitmap is set to ‘1’, a periodicity of the partial sensing operation may be 1000 ms (i.e., 10x100 ms). The terminal may perform the partial sensing operation according to the determined periodicities. In the LTE V2X supporting Release-14, the terminal may perform a sensing operation not only according to a periodicity in units of 100 ms, but also according to a periodicity in units of 20 ms or 50 ms. However, in the resource pool for P-UE(s), a partial sensing operation according to a periodicity in units of 20 ms or 50 ms may not be supported.

On the other hand, in the NR communication system, periodicities {1 ms, 2 ms, ... , 99 ms} as well as periodicities {0, 100 ms, 200 ms, ... , 1000 ms} may be supported. Among the above-described periodicities, n periodicities may be selected for a resource pool in advance, and the n periodicities may be preconfigured. The maximum value of n may be 16. The base station may transmit information of the n periodicities to the terminal. Information of the n periodicities may be included in configuration information of the resource pool. The information of the n periodicities may be transmitted by using at least one of system information, RRC message (e.g., common RRC message and/or UE-specific RRC message), MAC CE, or control information. In the case of the random selection operation, the terminal may autonomously select a resource without the above-described sensing operation. In the Release-14 LTE V2X, a resource pool capable of performing the above-described partial sensing operation and/or random sensing operation may be configured separately from a resource pool in which the full sensing operation should be performed. For each resource pool, only the full sensing operation may be configured to be performed, the partial sensing operation may be configured be performed, or both the random sensing operation and the partial sensing operation may be configured to be performed. In the case of the resource pool configured to perform both the random sensing operation and the partial sensing operation, the terminal may perform resource selection by selecting one resource selection scheme according to its implementation.

Hereinafter, methods for SL-PRS transmission in sidelink communication will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a transmitting terminal is described, a corresponding receiving terminal may perform an operation corresponding to the operation of the transmitting terminal. Conversely, when an operation of a receiving terminal is described, a corresponding transmitting terminal may perform an operation corresponding to the operation of the receiving terminal.

The 3GPP has introduced LTE-based positioning technologies in Release-9. In Release-9, LTE-based positioning technologies such as enhanced cell identity (ECID) and observed time difference of arrival (OTDOA) have been introduced, and the LTE positioning reference signal (PRS) has been newly defined therefor. In addition, positioning technologies such as assisted (A)-GNSS have been also introduced in Release-9. Further, in Release-11, a positioning technology based on uplink TDOA (UTDOA), which is another OTDOA form using uplink signals from a terminal, has been introduced.

The NR system has introduced functions for supporting NR-based positioning technologies from Release-16, and improvements have been made to improve the performance of positioning technologies in Release-17. However, the corresponding positioning technologies are all positioning technologies based on a Uu link-based between a terminal and a base station, and sidelink-based positioning technologies are not yet supported in the NR system. The sidelink-based V2X services require sidelink-based positioning technology support for collision avoidance or location tracking, and these technologies should be supported not only in-coverage situations but also in out-of-coverage situations. In addition, sidelink-based positioning technologies need to be supported for sidelink-based public safety services and other services. In order to support such the sidelink-based positioning technologies, transmission of a sidelink SL-PRS for precise positioning may be required. Accordingly, the present disclosure proposes SL-PRS transmission methods for supporting the sidelink-based positioning technologies.

### Configuration of Resources for SL-PRS Transmission

The SL-PRS for supporting sidelink positioning technologies may be preferably transmitted in SL slot(s). When a dedicated SL carrier is used, all slots of the SL carrier may be SL slots. However, when a UL carrier other than the dedicated SL carrier is used for sidelink communication, as described above, some of UL slots of a Uu link may be configured as SL slots. When the SL-PRS is transmitted in a part of a SL slot, since fragmentation of a PSCCH and/or PSSCH may occur if the SL-PRS is transmitted in the middle part of the SL slot, the SL-PRS may be preferably transmitted in the latter part of the SL slot. More specifically, it may be preferable that the SL-PRS is transmitted in the last N symbol(s) excluding a guard symbol in the SL slot. In this case, the N symbols may or may not include an AGC symbol.

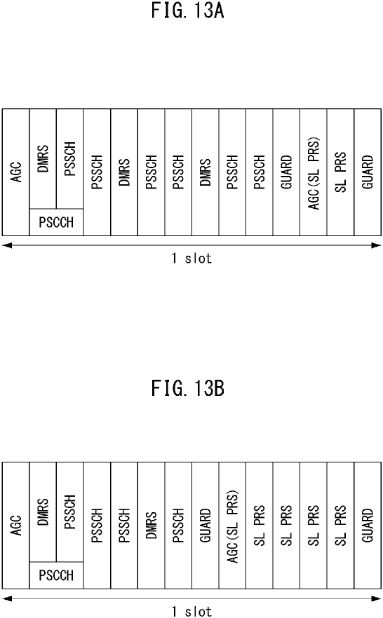

FIGS. 13A and 13B are conceptual diagrams illustrating cases in which N symbol(s) for SL-PRS transmission are configured within a SL slot according to an exemplary embodiment of the present disclosure.

FIG. 13A shows a case where N (=2) symbols for SL-PRS transmission are configured including one AGC symbol, and FIG. 13B shows a case where N (=5) symbols for SL-PRS transmission are configured including one AGC symbol. When N symbols within a slot are configured for SL-PRS transmission, N symbols from a symbol just before the last guard symbol of the corresponding slot may be used for SL-PRS transmission. It may be preferable to copy and transmit a symbol immediately following the AGC symbol, where SL-PRS transmission actually starts, in the first AGC symbol within the slot.

When N symbols for SL-PRS transmission do not include one AGC symbol, FIG. 13A corresponds to a case where one symbol is configured for SL-PRS transmission (i.e., N=1), and FIG. 13B corresponds to a case where 4 symbols are configured for SL-PRS transmission (i.e., N=4). Even when the N symbols for SL-PRS transmission do not include the AGC symbol, the AGC symbol may always be located in front of the symbols for SL-PRS transmission, and it may be preferable to copy and transmit a symbol immediately following the AGC symbol, where SL-PRS transmission actually starts, in the AGC symbol.

Alternatively, similarly to S-SSB, a method of configuring separate SL slot(s) for SL-PRS transmission and performing only SL-PRS transmission in the corresponding SL slot(s) may be used. When separate slot(s) for SL-PRS transmission are configured, in the resource allocation mode 1 in which a base station participates in sidelink resource scheduling, sidelink transmission and reception may be controlled by implementation not to occur in the separate slot(s) for SL-PRS transmission. However, in the case of the resource allocation mode 2 in which sidelink transmission and reception are performed based on sensing of a terminal without involvement of a base station, it may preferable that separate slot(s) for SL-PRS transmission are excluded from slots for sidelink data transmission and reception through the above-described SL slot configuration, similarly to the slots for S-SSB transmission. More specifically, the slots for SL-PRS transmission may be excluded when a bitmap is applied to slots other than the slots for S-SSB transmission in the SL slot configuration. Alternatively, similarly to the slots for S-SSB transmission, the slots for SL-PRS transmission may be excluded before applying the bitmap. The existing sidelink terminals may determine that sidelink transmission and reception do not occur in the slots for SL-PRS transmission, and the terminals performing SL-PRS transmission and reception may receive configuration information on the slots for SL-PRS transmission. Therefore, since the slots for SL-PRS transmission are separately configured in addition to the existing resource pool configuration, they may not be affected by the existing resource pool configuration. Alternatively, a separate resource pool for SL-PRS transmission may be configured. Also in this case, the existing resource pool configuration for performing sidelink transmission and reception may not be affected. In this case, symbol(s) for SL-PRS transmission may be configured within a slot for SL-PRS transmission similarly to the method described with reference to FIGS. 13A and 13B. In this case, since the symbol(s) for SL-PRS transmission may be configured in the remaining symbol(s) excluding the last guard symbol of the corresponding slot, configuration flexibility may be improved compared to a case where the SL-PRS is transmitted through a part of a SL slot excluding symbols in which sidelink data is transmitted.

Even when the SL-PRS is transmitted using the separate slot(s) or separate resource pool, AGC symbol transmission is required. Accordingly, similarly to the method described with reference to FIGS. 13A and 13B, the N symbols for SL-PRS transmission may or may not include the AGC symbol. Meanwhile, information on a periodicity and/or offset for SL-PRS transmission may be set in addition to the number of symbol(s) for SL-PRS transmission within a SL slot. The periodicity and/or offset for SL-PRS transmission may be preferably set based on SL logical slot(s) in which sidelink transmission/reception is actually performed.

In general, sidelink reference signals (e.g., DM-RS, CSI-RS, PT-RS) other than the SL-PRS are always transmitted in the same frequency region as that of PSCCH, PSSCH, or PSBCH. However, in order to improve positioning accuracy performance, it may be preferable to transmit the SL-PRS in a wide band. In addition, it may be preferable that the SL-PRS is not multiplexed with other signals or channels other than the SL-PRS. Therefore, the SL-PRS may be preferably transmitted in a separate frequency region regardless of the frequency region in which the PSCCH, PSSCH, and PSBCH are transmitted. Accordingly, similarly to the PSFCH, a separate frequency region for SL-PRS may be configured within a resource pool.

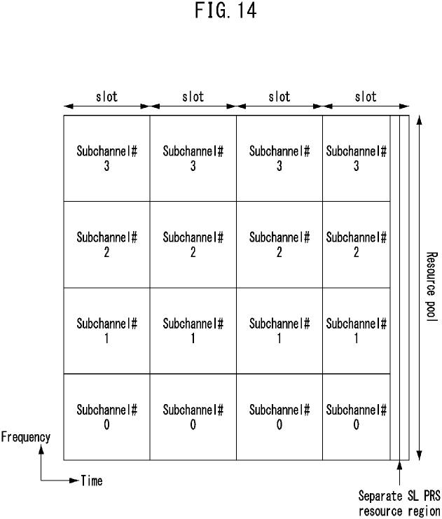

FIG. 14 is a conceptual diagram illustrating an example in which a separate resource region for SL-PRS transmission is configured within a SL resource pool according to an exemplary embodiment of the present disclosure.

Referring to FIG. 14, a resource region (e.g., frequency region) for SL-PRS transmission may be separately configured in the entire region or partial region of the SL resource pool. Since the SL-PRS is preferably transmitted as a contiguous wideband signal, the resource region (e.g., frequency region) for SL-PRS transmission may be configured with a position (or index) of a starting RB and the number (length) of RBs constituting the resource region (e.g., frequency region). Alternatively, the resource region (e.g., frequency region) for SL-PRS transmission may be configured with a position (or index) of a starting subchannel and the number (length) of subchannels constituting the resource region (e.g., frequency region).

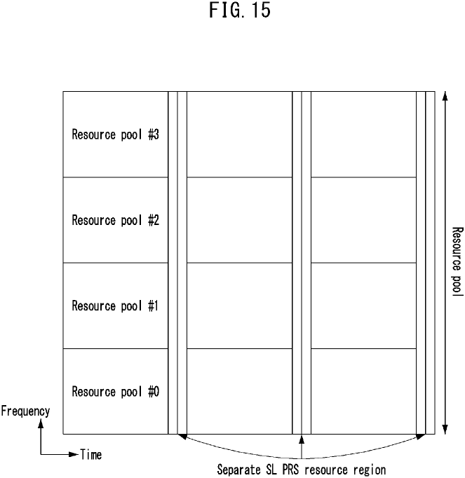

If it is necessary for the SL-PRS to be transmitted as a larger wideband signal, the resource region for SL-PRS transmission may be configured to be out of a range of the resource pool. More specifically, as shown in FIG. 15 to be described later, the resource region for SL-PRS transmission may not be limited to the SL resource pool for data transmission and reception, and a separate SL resource pool for the resource region for SL-PRS transmission may be configured. Alternatively, the resource region for SL-PRS transmission may be configured within a SL BWP based on the SL BWP, regardless of configuration of resource pools. Alternatively, the resource region for SL-PRS transmission may be configured as a larger frequency region including or not including the SL BWP.

FIG. 15 is a conceptual diagram illustrating an example in which a resource pool for SL-PRS transmission is configured separately from SL resource pools configured for sidelink data transmission and reception according to an exemplary embodiment of the present disclosure.

Referring to FIG. 15, a resource region for SL-PRS transmission may be configured as a separate frequency resource region not limited to a SL resource pool. The frequency resource region may be configured with a position of the starting RB and the number (length) of RBs constituting the resource region, or may be configured with a position of the starting subchannel and the number (length) of subchannels.

In order to measure the SL-PRS in a region outside the resource pool where data transmission/reception actually occurs, it may be necessary to configure a separate measurement gap. When the separate measurement gap is configured, measurement on the SL-PRS may be performed even in a resource region other than the SL-BWP.

Within the configured frequency region, a comb-type mapping in which the SL-PRS is mapped at a predetermined interval of subcarriers may be applied. In this case, a plurality of starting positions may be configured according to the interval of subcarriers, and when the SL-PRS is transmitted in a plurality of symbols, different frequency offset values may be applied to the respective symbols. Therefore, when the SL-PRS is mapped to N symbols, the SL-PRS may be transmitted at least once in each subcarrier in the entire frequency region by changing the position where the SL-PRS is mapped for each symbol. For example, when 4 symbols for SL-PRS transmission (excluding an AGC symbol) are configured, the interval D of subcarriers to which a SL-PRS sequence is mapped in the comb-type mapping may be preferably set to be less than or equal to N (i.e., D ≤ N). For example, when N is set to 4, D is set to 4, and the SL-PRS sequence is mapped by changing the position to which the SL-PRS sequence is mapped for each symbol, the SL-PRS sequence may be mapped once to each of all subcarriers within the frequency region. As another example, when N is set to 4 and D is set to 2, the SL-PRS sequence may be mapped twice to each of all subcarriers within the frequency region.

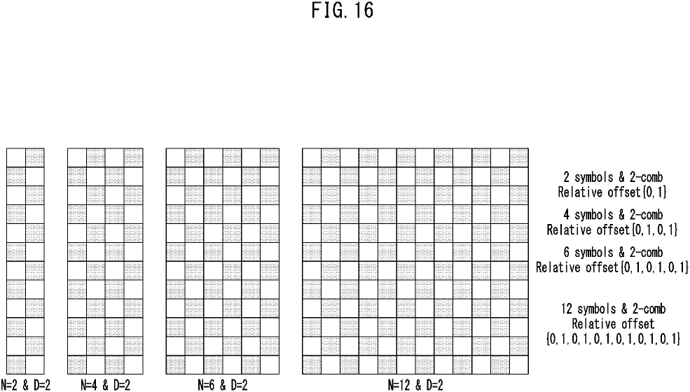

FIG. 16 is a conceptual diagram for describing SL-PRS sequence mapping within a resource region for SL-PRS transmission according to an exemplary embodiment of the present disclosure.

When N symbols for SL-PRS transmission do not include an AGC symbol, the interval D of subcarriers may be set to be less than or equal to N, and the SL-PRS may be transmitted in different subcarriers to which different offsets are respectively applied in units of D symbols.

Referring to FIG. 16, when N is set to 2, 4, 6, or 12, D is set to 2, and a set of offsets is configured as {0, 1}, if a SL-PRS sequence is mapped in units of two symbols, the SL-PRS sequence may be transmitted in the entire frequency region over two symbols by respectively applying the offsets 0 and 1 to the two symbols. In this case, a position of a subcarrier to which the SL-PRS is first transmitted may also be selected from D offsets. That is, the position of the subcarrier to which the SL-PRS is first transmitted may also be configured by a value of {0, 1}. FIG. 16 illustrates a case in which the position of the subcarrier in which the SL-PRS is first transmitted is configured as 0. In this manner, if the starting position is configured separately and a different offset is applied to each symbol based on the starting position, SL-PRS mapping patterns that do not overlap with each other may be configured according to the configuration of the starting position. Therefore, when different SL-PRS starting positions are configured for a plurality of terminals, SL-PRS transmission without interference between the terminals may be possible.

The above-described SL-PRS configuration information (e.g., N, transmission periodicity information, frequency region configuration information, comb type, starting position, offset information configuration, and/or the like) may be configured through system information, PC5-RRC signaling, UE-specific RRC signaling, a separate protocol for positioning (e.g., LTE positioning protocol (LPP) or NR positioning protocol annex (NRPPa)), or a combination thereof.

### SL-PRS Transmission Schemes

The SL-PRS may be transmitted in a periodic scheme, semi-persistent/periodic scheme, or aperiodic scheme in association with the periodicity information.

In the case of the periodic transmission scheme, after a certain time from when the SL-PRS configuration information is received (from the base station or another terminal), the terminal may periodically transmit the SL-PRS according to the configured parameters. In the case of the semi-persistent/periodic transmission scheme, if a separate transmission trigger indicator (i.e., activation command) is additionally received (from the base station or another terminal) after the SL-PRS configuration information is received, the terminal may transmit feedback information on whether the indicator has been successfully received, and start periodic SL-PRS transmission. The terminal may continue transmitting the SL-PRS until receiving a separate stop indicator (i.e., deactivation command). In this case, the indicator may be a 1-bit indicator included in a MAC-CE or SCI (e.g., 1^{st} or 2^{nd} SCI). Alternatively, a case in which specific field(s) of a MAC-CE or SCI indicate a specific state may replace the role of the indicator. Alternatively, the indicator may be transmitted on a separate channel other than the MAC-CE or SCI.

In the case of the aperiodic transmission scheme, similarly to the semi-persistent/periodic transmission scheme, upon receiving a separate trigger indicator (i.e., activation command) (from the base station or another terminal), the terminal may perform SL-PRS transmission. Unlike the semi-persistent/periodic transmission scheme, in the case of the aperiodic SL-PRS transmission scheme, the terminal may not transmit the SL-PRS periodically, but may transmit the SL-PRS once or a predetermined number of times after receiving the trigger indicator. Alternatively, information on the number of transmissions may be received together with the trigger indicator. In general, since positioning accuracy may increase as the number of SL-PRS transmissions increases, it may be preferable to continuously and repeatedly transmit the SL-PRS for a certain period of time even in the aperiodic SL-PRS transmission scheme to increase the positioning accuracy. The indicator for aperiodic SL-PRS transmission may be a 1-bit indicator included in a MAC-CE or SCI (e.g., 1^{st} or 2^{nd} SCI). Alternatively, a case in which specific field(s) of a MAC-CE or SCI indicate a specific state may replace the role of the indicator. Alternatively, the indicator may be transmitted on a separate channel other than the MAC-CE or SCI. When information on the number of transmissions is separately transmitted, the corresponding information may also be transmitted as included in the MAC-CE or SCI (e.g., 1^{st} or 2^{nd} SCI). Alternatively, a case where specific field(s) of a MAC-CE or SCI indicates a specific state may replace the information on the number of transmissions. Alternatively, the information on the number of transmissions may be transmitted on a separate channel other than the MAC-CE or SCI. In the case of the semi-persistent/periodic transmission scheme or the aperiodic transmission scheme, the trigger indicator and the SL-PRS configuration information may be received together (from the base station or another terminal). Alternatively, when a plurality of SL-PRS configuration information is configured in advance, an index indicating which SL-PRS configuration information among the plurality of SL-PRS configuration information is to be applied may be received along with the trigger indicator (from the base station or another terminal).

In the case of the semi-persistent/periodic transmission scheme or the aperiodic SL-PRS transmission scheme, the trigger indicator and/or stop indicator may be transmitted to the terminal through the base station. Alternatively, when necessary, a specific terminal (e.g., UE-A) may request another terminal (e.g., UE-B) to perform SL-PRS transmission or stop the SL-PRS transmission. Such the function of requesting to start or stop SL-PRS transmission between terminals may be enabled or disabled by pre-configuration of the base station. In this case, the request message may be transmitted through a MAC-CE or SCI (e.g., 1^{st} or 2^{nd} SCI) as described above.

When the SL-PRS is transmitted periodically, the transmission periodicity and offset of the SL-PRS may be set as described above. In this case, the transmission periodicity and offset of the SL-PRS may be set in consideration of the transmission periodicity of the PSFCH, which is another channel that is periodically configured. More specifically, the transmission periodicity of the SL-PRS may be set to coincide with the transmission periodicity of the PSFCH, or set to be a multiple of the transmission periodicity of the PSFCH. In this case, a slot in which the SL-PRS is transmitted and a slot in which the PSFCH is transmitted may be configured not to overlap each other by applying different offsets to the same periodicity or the periodicities of the PSFCH and SL-PRS. Alternatively, the slot in which the SL-PRS is transmitted and the slot in which the PSFCH is transmitted may be configured to overlap by applying the same offset to the same periodicity or the periodicities of the PSFCH and SL-PRS. In this case, a symbol(s) in which the SL-PRS is transmitted may be configured in consideration of a symbol(s) in which the PSFCH is transmitted and a guard symbol within the corresponding slot. For example, referring to the slot structure of FIG. 10, the SL-PRS may be mapped from a symbol excluding a total of four symbols including the last guard symbol, two symbols for the PSFCH (including an AGC symbol), and a guard symbol before the PSFCH symbol. In this case, the number of symbols for PSCCH/PSSCH transmission within the corresponding slot is reduced. Alternatively, the SL-PRS may be configured to be transmitted only in the same region as the PSFCH symbol. Since the PSFCH is transmitted over 2 symbols including the AGC symbol, the SL-PRS may also be configured to be transmitted over 2 symbols including the AGC symbol. Since the PSFCH is transmitted in a frequency region configured with the bitmap within the corresponding resource pool, the SL-PRS may be configured to be transmitted in the remaining region excluding the region in which the PSFCH is transmitted.

### Collision Between SL-PRS and PSFCH

When the SL-PRS is transmitted periodically, as described above, the transmission periodicity and offset of the SL-PRS may be set separately from the transmission periodicity and offset of the PSFCH. However, the slot(s) in which the SL-PRS is transmitted and the slots in which the PSFCH is transmitted may overlap at least partially, and thus a collision may occur.

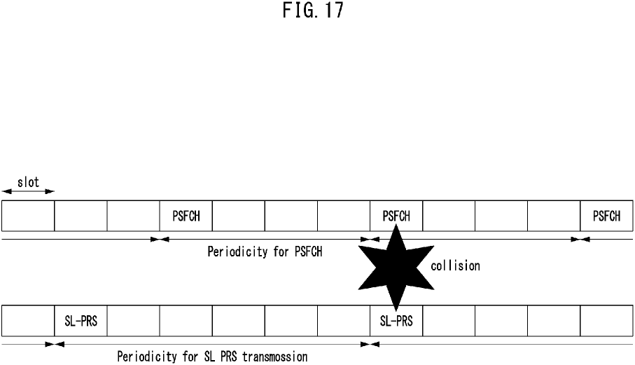

FIG. 17 is a conceptual diagram illustrating a case in which a collision occurs between a slot in which a SL-PRS is transmitted and a slot in which a PSFCH is transmitted according to an exemplary embodiment of the present disclosure.

Referring to FIG. 17, even when the slot in which the SL-PRS is transmitted and the slot in which the PSFCH is transmitted are the same, if a SL-PRS transmission/reception period (i.e., symbol(s)) and a PSFCH transmission/reception period (i.e., symbol(s)) are different, the terminal may individually perform a SL-PRS transmission/reception operation and a PSFCH transmission/reception operation. However, when the SL-PRS transmission/reception period (i.e., symbol(s)) and the PSFCH transmission/reception period (i.e., symbol(s)) overlap within the same slot, the terminal may perform all or a part of the SL-PRS transmission/reception operation and the PSFCH transmission/reception operation.

When SL-PRS transmission and PSFCH transmission overlap, a terminal capable of simultaneously performing SL-PRS transmission and PSFCH transmission may simultaneously perform the SL-PRS transmission and the PSFCH transmission. However, a terminal not capable of simultaneously performing SL-PRS transmission and PSFCH transmission may perform either the SL-PRS transmission or the PSFCH transmission by selecting one of the SL-PRS transmission and the PSFCH transmission. In this case, when a priority of the SL-PRS is set separately, the terminal may compare the priority of the SL-PRS and a priority of the PSFCH, and when the priority of the SL-PRS is higher than the priority of the PSFCH, the terminal may perform the SL-PRS transmission. On the other hand, when the priority of the SL-PRS is lower than the priority of the PSFCH, the terminal may drop the SL-PRS transmission and transmit the PSFCH. When the priority of the SL-PRS is not separately set, the terminal may drop the SL-PRS transmission and transmit the PSFCH, assuming that the PSFCH always has a higher priority than the SL-PRS. Alternatively, the terminal may drop the PSFCH transmission and transmit the SL-PRS, assuming that the PSFCH always has a lower priority than the SL-PRS.

When SL-PRS reception and PSFCH reception overlap, a terminal capable of simultaneously performing SL-PRS reception and PSFCH reception may simultaneously perform the SL-PRS reception and the PSFCH reception. A terminal not capable of simultaneously performing SL-PRS reception and PSFCH reception may perform either the SL-PRS reception or the PSFCH reception by selecting one of the SL-PRS reception and the PSFCH reception. In this case, when the priority of the SL-PRS is set separately, the terminal may compare the priority of the SL-PRS and the priority of the PSFCH, and when the priority of the SL-PRS is higher than the priority of the PSFCH, may perform the SL-PRS reception. On the other hand, when the priority of the SL-PRS is lower than the priority of the PSFCH, the terminal may drop the SL-PRS reception and receive the PSFCH. When the priority of the SL-PRS is not set separately, similarly to the above-described transmission procedure, the terminal may always drop the SL-PRS reception or conversely always perform only the SL-PRS reception regardless of the priority of the PSFCH.

When SL-PRS transmission (or reception) and PSFCH reception (or transmission) overlap, since the terminal cannot perform transmission and reception operations at the same time, the terminal may perform either the SL-PRS transmission (or reception) or the PSFCH reception (or transmission). In this case, when the priority of the SL-PRS is set separately, the terminal may compare the priority of the SL-PRS and the priority of the PSFCH, and when the priority of the SL-PRS is higher than the priority of the PSFCH, may transmit (or receive) the SL-PRS. On the other hand, when the priority of the SL-PRS is lower than the priority of the PSFCH, the terminal may drop the SL-PRS transmission (or reception) and perform the PSFCH reception (or transmission). Similarly to the above-described procedures, when the priority of SL-PRS is not separately set, the terminal may always drop the SL-PRS transmission (or reception), or conversely always perform the SL-PRS transmission (or reception) regardless of the priority of the PSFCH.

When LTE/NR PSCCH/PSSCH transmission/reception, UL transmission, and SL-PRS transmission (or reception) overlap, when the priority of the SL-PRS is set separately, the terminal may determine a final priority by comparing the priority of the LTE/NR PSCCH/PSSCH transmission/reception, the priority of the UL transmission, and the priority of the SL-PRS transmission (or reception), and perform a transmission or reception operation according to the determined final priority. When the priority of the SL-PRS is not separately set, the terminal may always drop the SL-PRS transmission (or reception), or conversely always perform the SL-PRS transmission (or reception).

### SL-PRS Measurement Result Report

A terminal receiving a SL-PRS may need to report a measurement result of the SL-PRS to a base station, a location management function (LMF) or another terminal. In this case, reporting to the base station or LMF may be performed through the existing uplink and/or existing LPP protocols, and reporting to another terminal may be performed through a sidelink and/or a MAC-CE. The type of measurement results reported by the terminal for positioning may vary depending on the positioning scheme.

For example, in the case of the OTDOA scheme, overall information on the measured PRS (e.g., physical cell ID, global cell ID, PRS ID, PRS resource ID, PRS resource set ID, frequency position (ARFCN), and/or the like), information on a time at which the measurement was made (e.g., index of a specific slot), timing information on a relative timing from a specific reference, quality information of the timing information, RSRP measurement information, and/or the like may be reported. Depending on configuration, information on a path may also be reported. In the case of the multi-round trip time (multi-RTT) scheme, unlike the OTDOA scheme, an RX-TX time difference may be reported instead of the timing information. In the case of the angle-based positioning scheme, information on a reception beam or the like capable of inferring a reception angle may be reported instead of the timing information.

When the timing-based positioning scheme such as TDOA and RTT or the angle-based positioning scheme such as AOA and AOD is used for sidelink positioning, a positioning process may be performed by reporting the same or similar measurement results as the existing measurement results. However, a procedure for measuring and reporting measurement results considering a sidelink positioning environment different from that of the existing Uu link may be required.

In the case of the timing-based positioning scheme such as the OTDOA scheme, it may be necessary to report information on a relative timing from a specific reference time. In this case, in the conventional scheme, a method of defining a reference cell and measuring and reporting a relative timing based on a reception timing of a PRS from the reference cell may be used. However, in sidelink positioning, a reference may be configured as a specific terminal (i.e., reference terminal) rather than a specific cell. In this case, information on the reference terminal may be an ID (e.g., TX ID) of the reference terminal, and the information may be delivered to other terminals performing positioning as being included in positioning assistant information. As the positioning assistant information, in addition to the ID of the reference terminal, information on a time at which the PRS from the corresponding terminal is expected to be received (e.g., nr-SL-PRS-ExpectedRSTD) and information on an offset value (e.g., +/-value) from the time at which the PRS is expected to be received (e.g., nr-DL-PRS-ExpectedRSTD-Uncerainty) may be used. In this case, other terminals performing sidelink positioning may reduce positioning complexity by setting a reception timing from the reference terminal, which is predictable to some extent.

In addition, in the case of a carrier phase-based positioning scheme, which is being discussed to be newly introduced in sidelink and Uu link positioning, a measurement result report different from the existing one is required. For example, it may be required to report measurement values such as a relative phase difference (e.g., reference signal phase difference (RSPD)) from a specific reference, and quality information for the measurement values such as a phase quality value (e.g., phaseQualityValue) and a phase quality resolution value (e.g., phaseQualityResolution). More specifically, in the case of the RSPD, a resolution step for a phase difference value may be set differently according to various positioning situations, and may be set in advance by the LMF or a terminal requesting measurement. In addition, the phase quality value may be an estimated value for uncertainty of the phase difference value and may be expressed as a degree, and the phase quality resolution may be a value representing a resolution to which the phase quality value is applied, and may be reported as one of various values (e.g., 0.01, 0.1, 1, 10, or 20 degrees). As the measurement results for the timing-based or angle-based positioning scheme can be applied without a significant difference between Uu link positioning and sidelink positioning, the above-described measurement results for the carrier phase-based positioning scheme may be applied to Uu link positioning and sidelink positioning without a significant difference therebetween when it is applied to the Uu link positioning and sidelink positioning.

The above-described SL-PRS transmission and reception related configurations, measurement and reporting procedure related configurations, and/or the like for precise positioning may be performed by the base station to which the terminals performing positioning belong, LMF, or both the base station and LMF (i.e., Scheme 1). Alternatively, the configurations may be performed by a terminal among the terminals performing positioning or a terminal other than the terminals (i.e., Scheme 2).

In this case, as a method of indicating whether to operate based on Scheme 1 or Scheme 2, Scheme 1 or Scheme 2 may be implicitly configured according to whether a group of the terminals performing positioning exists within a network coverage (e.g., Scheme 1 in case of in-coverage state, and Scheme 2 in case of out-of-coverage state), or may be explicitly configured by the base station. Alternatively, a method of operating in Scheme 2 in the out-of-coverage state and operating in Scheme 1 or Scheme 2 according to a configuration of the base station in the in-coverage state may also be applied.

Synchronization between terminals is very important in performing precise positioning. In particular, in the case of timing-based positioning schemes, synchronization between terminals should be acquired so that transmission/reception and measurement of the SL-PRS are accurately performed to obtain high positioning accuracy. Therefore, configuration of a clear reference for synchronization between terminals should be made. In the case of Scheme 1, the reference for synchronization between terminals may be a corresponding base station. Alternatively, a GNSS or a specific terminal (e.g., reference UE) may be configured as the reference for synchronization between terminals by the base station. In this case, the base station transmitting configuration information of Scheme 1 may include information on which one of a base station, GNSS, and specific terminal (e.g., reference UE) the synchronization reference is in the configuration information. When a specific terminal (e.g., reference UE) is the reference for synchronization between terminals, information on the specific terminal (e.g., TX ID or UE ID) may be additionally included in the configuration information. When a base station is the reference for synchronization between terminals, if the base station (e.g., reference gNB) serving as the reference is different from the base station transmitting the configuration information, information on the reference gNB (e.g., Cell ID) may be additionally included in the configuration information. If the base station serving as the reference for synchronization between terminals and the base station transmitting the configuration information are the same, since the terminals performing positioning already know the information of the corresponding base station, the information on the base station serving as the reference for synchronization between terminals need not be included in the configuration information. In the case of Scheme 2, information on which one of a terminal transmitting configuration information of Scheme 2, another specific terminal (e.g., reference UE), specific base station (e.g., reference gNB), and GNSS the reference for synchronization between terminals is may be included in the configuration information. When a specific terminal (e.g., reference UE) or a specific base station (e.g., reference gNB) is configured as the reference for synchronization between terminals, information on the specific terminal or the specific base station (e.g., TX ID, terminal ID, or cell ID) may be additionally included in the configuration information.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A sidelink positioning reference signal (SL-PRS) transmission method performed by a first terminal, comprising:
receiving configuration information for SL-PRS transmission; and
transmitting a SL-PRS based on the configuration information,
wherein the configuration information includes information indicating sidelink (SL) slot(s) and symbols within the SL slot(s) in which the SL-PRS is transmitted.

2. The SL-PRS transmission method according to claim 1, wherein the SL slot(s) in which the SL-PRS is transmitted are configured regardless of a resource pool for sidelink data transmission and reception, or configured in a separate resource pool for SL-PRS transmission.

3. The SL-PRS transmission method according to claim 1, wherein the SL-PRS is transmitted in last N symbol(s) excluding a last guard symbol within a first slot among the SL slot(s) in which the SL-PRS is transmitted, the N symbol(s) include or do not include an automatic gain control (AGC) symbol, and N is a natural number equal to or greater than 1.

4. The SL-PRS transmission method according to claim 1, wherein the SL-PRS is transmitted in a first frequency region other than a frequency region in which a physical sidelink control channel (PSCCH), a physical sidelink shared channel (PSSCH), and a physical sidelink broadcast channel (PSBCH) are transmitted.

5. The SL-PRS transmission method according to claim 4, wherein the first frequency region is indicated by an index indicating a starting resource block (RB) or a starting subchannel and a number of consecutive RBs or subchannels.

6. The SL-PRS transmission method according to claim 4, wherein the SL-PRS is mapped in a comb-type form at an interval of D subcarriers within the first frequency region; when the SL-PRS is transmitted in a plurality of symbols, the SL-PRS is transmitted in the plurality of symbols by applying a different frequency offset to each symbol of the plurality of symbols; and D is a natural number equal to or greater than 2.

7. The SL-PRS transmission method according to claim 1, wherein the configuration information is received from a first base station to which the first terminal is connected, a location management function (LMF), or a second terminal belonging to a group of terminals performing sidelink positioning with the first terminal.

8. The SL-PRS transmission method according to claim 7, wherein from which communication node among the first base station, the LMF, and the second terminal the configuration information is received is determined according to whether the first terminal is in an in-coverage state or an out-of-coverage state and/or a configuration of the first base station.

9. The SL-PRS transmission method according to claim 7, wherein the SL-PRS is transmitted in a periodic transmission scheme, a semi-persistent/periodic transmission scheme, or an aperiodic transmission scheme.

10. The SL-PRS transmission method according to claim 9, wherein when a trigger indicator is received from the first base station or the second terminal, the SL-PRS is repeatedly transmitted a predetermined number of times in the aperiodic transmission scheme, and the predetermined number is a preset value, a value signaled as being included in the configuration information, or a value signaled by a medium access control-control element (MAC-CE) or sidelink control information (SCI).

11. The SL-PRS transmission method according to claim 9, wherein the configuration information further includes information on a periodicity and/or offset of the SL-PRS transmission, and when the SL-PRS is transmitted in the periodic transmission scheme, the periodicity of the SL-PRS transmission is set to match a transmission periodicity of a physical sidelink feedback channel (PSFCH) or to be a multiple of the transmission periodicity of the PSFCH.

12. The SL-PRS transmission method according to claim 11, wherein different offsets are applied to a slot in which the SL-PRS is transmitted and a slot in which the PSFCH is transmitted, or a same offset is applied to the slot in which the SL-PRS is transmitted and the slot in which the PSFCH is transmitted.

13. An operation method of a communication node for configuring sidelink positioning reference signal (SL-PRS) transmission, the operation method comprising:
transmitting, to a first terminal, configuration information for SL-PRS transmission; and
receiving, from a group of terminals performing sidelink positioning with the first terminal, a measurement result of a SL-PRS transmitted by the first terminal based on the configuration information,
wherein the configuration information includes information indicating sidelink (SL) slot(s) and symbols within the SL slot(s) in which the SL-PRS is transmitted.

14. The operation method according to claim 13, wherein the SL slot(s) in which the SL-PRS is transmitted are configured regardless of a resource pool for sidelink data transmission and reception, or configured in a separate resource pool for SL-PRS transmission.

15. The operation method according to claim 13, wherein the SL-PRS is transmitted in a first frequency region other than a frequency region in which a physical sidelink control channel (PSCCH), a physical sidelink shared channel (PSSCH), and a physical sidelink broadcast channel (PSBCH) are transmitted.

16. The operation method according to claim 15, wherein the SL-PRS is mapped in a comb-type form at an interval of D subcarriers within the first frequency region; when the SL-PRS is transmitted in a plurality of symbols, the SL-PRS is transmitted in the plurality of symbols by applying a different frequency offset to each symbol of the plurality of symbols; and D is a natural number equal to or greater than 2.

17. The operation method according to claim 13, wherein the communication node is a first base station to which the first terminal is connected, a location management function (LMF), or a second terminal belonging to a group of terminals performing sidelink positioning with the first terminal.

18. A first terminal performing sidelink positioning reference signal (SL-PRS) transmission, comprising:
a processor; and
a transceiver controlled by the processor,
wherein the processor is configured to perform:
receiving configuration information for SL-PRS transmission through the transceiver; and
transmitting a SL-PRS through the transceiver based on the configuration information,
wherein the configuration information includes information indicating sidelink (SL) slot(s) and symbols within the SL slot(s) in which the SL-PRS is transmitted.

19. The first terminal according to claim 18, wherein the SL slot(s) in which the SL-PRS is transmitted are configured regardless of a resource pool for sidelink data transmission and reception, or configured in a separate resource pool for SL-PRS transmission.

20. The first terminal according to claim 18,
wherein the SL-PRS is transmitted in a first frequency region other than a frequency region in which a physical sidelink control channel (PSCCH), a physical sidelink shared channel (PSSCH), and a physical sidelink broadcast channel (PSBCH) are transmitted, and
wherein the SL-PRS is mapped in a comb-type form at an interval of D subcarriers within the first frequency region; when the SL-PRS is transmitted in a plurality of symbols, the SL-PRS is transmitted in the plurality of symbols by applying a different frequency offset to each symbol of the plurality of symbols; and D is a natural number equal to or greater than 2.
